(19) United States
(12) Patent Application Publication
(10) Pub. No.: US 2026/0088414 A1
(43) Pub. Date: Mar. 26, 2026

(54) ALL-SOLID SECONDARY BATTERY AND METHOD OF PREPARING THE SAME

(71) Applicant: Samsung SDI Co., Ltd., Yongin-si (KR)

(72) Inventors: Dongil Kang, Suwon-si (KR); Wonsung Choi, Suwon-si (KR)

(21) Appl. No.: 19/050,356

(22) Filed: Feb. 11, 2025

(30) Foreign Application Priority Data
Sep. 26, 2024 (KR) 10-2024-0131041

(51) Int. Cl. H01M 50/242; H01M 4/02; H01M 4/36; H01M 10/052; H01M 10/0562; H01M 10/0587; H01M 50/122

(52) U.S. Cl. CPC H01M 50/242; H01M 4/366; H01M 10/052; H01M 10/0562; H01M 10/0587; H01M 50/122; H01M 2004/021; H01M 2004/027; H01M 2004/028

(57) ABSTRACT

An all-solid secondary battery and a method of preparing the same, the all-solid secondary battery including a unit cell and a compression assistance layer on at least one surface of the unit cell, the unit cell including an electrode assembly and an exterior material on the electrode assembly, the electrode assembly including a cathode layer, an anode layer, and a solid electrolyte layer between the cathode layer and the anode layer, wherein a buckling deformation point of the compression assistance layer is 100 megaPascals or more.

### CROSS-REFERENCE TO RELATED APPLICATION

This application is based on and claims priority to Korean Patent Application No. 10-2024-0131041, filed on Sep. 26, 2024, in the Korean Intellectual Property Office and all the benefits accruing therefrom under 35 USC § 119, the content of which herein is incorporated by reference in its entirety.

### BACKGROUND

### 1. Field

The disclosure relates to an all-solid secondary battery and a method of preparing the same.

### 2. Description of the Related Art

The development of batteries that provide increased energy density and safety has been actively pursued recently. Lithium batteries are used in various information devices, communication devices, and automobiles, among other applications. Since automobiles are directly related to human life, safety is crucial. Lithium batteries containing liquid electrolytes include flammable organic solvents. Lithium batteries with liquid electrolytes have a high risk of overheating and fire during a short circuit. Compared to liquid electrolytes, solid electrolytes have a reduced risk of overheating and fire during a short circuit. Lithium batteries with solid electrolytes may provide improved safety as compared to lithium batteries with liquid electrolytes.

### SUMMARY

Provided is an all-solid secondary battery having a reduced porosity and improved charge-discharge characteristics by including a compression assistance layer that enables uniform compression of a cathode layer.

Additional aspects will be set forth in part in the description which follows and, in part, will be apparent from the description, or may be learned by practice of the presented embodiments of the disclosure.

According to an aspect, an all-solid secondary battery includes:
a unit cell and a compression assistance layer on at least one side of the unit cell,
the unit cell including an electrode assembly and an exterior material on the electrode assembly,
the electrode assembly including a cathode layer, an anode layer and a solid electrolyte layer between the cathode layer and the anode layer,
wherein a buckling deformation point of the compression assistance layer is 100 megaPascals (MPa) or more.

According to another aspect, an all-solid secondary battery includes:
a unit cell and a compression assistance layer on at least one side of the unit cell,
the unit cell including an electrode assembly and an exterior material on the electrode assembly,
the electrode assembly including a cathode layer, an anode layer, and a solid electrolyte layer between the cathode layer and the anode layer,
wherein the compression assistance layer includes a first side adjacent to the cathode active material layer, and a second side opposing the first side,
wherein the surface of the cathode active layer includes a first protrusion and a first recess, and
wherein the first side of the compression assistance layer includes a second recess corresponding to the first protrusion and a second protrusion corresponding to the first recess.

According to another aspect, a method of preparing an all-solid secondary battery includes:
providing a unit cell that includes an electrode assembly and an exterior material on the electrode assembly, the electrode assembly including a cathode layer having a first porosity, an anode layer, and a solid electrolyte layer between the cathode layer and the anode layer;
arranging a compression assistance layer on at least one side of the unit cell; and
simultaneously compressing the unit cell and the compression assistance layer to prepare the all-solid secondary battery wherein the cathode layer has a second porosity that is less than the first porosity,
wherein a buckling deformation point of the compression assistance layer is 100 MPa or more.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a stress-strain diagram for the films used in Examples 1, 6, 7, and 9 and Comparative Example 1;

FIG. 2 is a Young's modulus-strain diagram illustrating Young's modulus (megaPascals, MPa) versus strain of the films used in Examples 1, 6, 7, and 9 and Comparative Example 1;

FIG. 3 is a graph showing discharge profiles (voltage (V) versus capacity (milliampere-hours per gram, mAh/g)) for all-solid secondary batteries manufactured in Examples 1, 3 and 6 and Comparative Examples 1 and 2;

FIG. 4 is a graph showing the life characteristics (capacity (milliampere-hours per gram, mAh/g) versus cycle) of all-solid secondary batteries manufactured in Example 1, Example 4, and Comparative Example 1;

FIG. 5 is a cross-sectional view of an all-solid secondary battery according to an embodiment;

FIG. 6 is a cross-sectional view of an all-solid secondary battery according to another embodiment;

FIG. 7 is a cross-sectional view of an all-solid secondary battery laminate according to another embodiment; and

FIG. 8 is a schematic diagram showing a cross-section of a cathode layer of an all-solid secondary battery according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Various embodiments have been illustrated in the accompanying drawings. However, the inventive concept may be embodied in many other forms and should not be construed as limited to the embodiments described herein. Rather, these embodiments are provided so that the disclosure may be thorough and complete and to fully convey the scope of the inventive concept to those skilled in the art. Identical reference numerals denote identical components.

When a component is described as being “on” another component, it may be directly on another component or intervening components may be present. In contrast, when a component is described as being “directly on” another component, no intervening components are present.

Terms such as “first,” “second,” and “third” may be used herein to describe various components, ingredients, regions, layers, and/or zones, but are not limited by these terms. These terms are used only to distinguish one component, ingredient, region, layer or zone from another component, ingredient, region, layer, or zone. Accordingly, a first component, ingredient, region, layer, or zone described below may be referred to as a second component, ingredient, region, layer, or zone without departing from the teachings of this disclosure.

The terminology used herein is for the purpose of describing particular embodiments only and is not intended to limit the inventive concept. As used herein, the singular form is intended to include the plural form including “at least one,” unless the context clearly dictates otherwise. The term “at least one” should not be construed as being limited to a singular form. As used herein, the term “and/or” includes any and all combinations of one or more of the listed items. The terms “comprises” and/or “comprising,” as used in the detailed description, specify the presence of stated features, regions, integers, steps, operations, components, and/or elements, but do not preclude the presence or addition of one or more other features, regions, integers, steps, operations, components, elements, and/or groups thereof.

Spatially relative terms, such as “beneath,” “below,” “lower,” “above,” “upper,” “top,” and the like, may be used herein to describe a relationship between one component or feature and another component or feature. It will be understood that spatially relative terms are intended to encompass different orientations of the device when used or operated in addition to the orientations depicted in the drawings. For example, if a device in the drawings is turned upside down, components or features described as “below” or “beneath” other components or features would then be oriented “above” the other components or features. Thus, the term “below” may encompass both upward and downward directions. The device may be disposed in other orientations (rotated 90 degrees or otherwise), and the spatially relative terms used herein may be interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10% or ±5% or ±3% of the stated value.

Unless otherwise defined, all terms (including technical and scientific terms) used herein have the same meaning as commonly understood by one of ordinary skill in the art to which this disclosure belongs. It will also be understood that terms such as those defined in commonly used dictionaries should be interpreted as having meanings consistent with the context of the relevant art and the disclosure, and should not be interpreted in an idealized or overly formal sense.

Embodiments are described herein with reference to schematic cross-sectional views of idealized embodiments. As such, variations from the shapes of the illustrations resulting from manufacturing techniques and/or tolerances are to be expected. Thus, the embodiments described herein should not be construed as limited to the specific shapes of regions illustrated, but are to include deviations in shapes resulting from manufacturing. For example, regions illustrated or described as being flat may be rough and/or include nonlinear features. Moreover, sharp angles illustrated may be rounded. Thus, the regions illustrated in the drawings are schematic in nature and their shapes are not intended to illustrate precise shapes of regions, nor are they intended to limit the scope of the claims.

The term “Group” refers to the groups in the periodic table of elements according to the 1-18 group classification system of the International Union of Pure and Applied Chemistry (“IUPAC”).

In this specification, “particle size” refers to the average diameter for spherical particles and the average long axis length for non-spherical particles. Particle size may be measured using a particle size analyzer (PSA). “Particle size” refers to, for example, the average particle size. “Average particle size” refers to, for example, the median particle diameter, D50.

D50 is the particle size corresponding to 50% cumulative volume in the particle size distribution measured by the laser diffraction method, calculated from the smaller particle size side.

D90 is the particle size corresponding to 90% cumulative volume in the particle size distribution measured by the laser diffraction method, calculated from the smaller particle size side.

D10 is the particle size corresponding to 10% cumulative volume in the particle size distribution measured by the laser diffraction method, calculated from the smaller particle size side.

As used herein, “metal” refers to both metals and metalloids, such as silicon and germanium, in elemental or ionic states.

As used herein, “alloy” refers to a mixture of two or more metals.

As used herein, “electrode active material” refers to an electrode material capable of undergoing lithiation and delithiation.

As used herein, “cathode active material” refers to a cathode material capable of undergoing lithiation and delithiation.

As used herein, “anode active material” refers to an anode material capable of undergoing lithiation and delithiation.

As used herein, “lithiation” and “to lithiate” refers to a process of adding lithium to an electrode active material.

As used herein, “delithiation” and “to delithiate” refers to a process of removing lithium from an electrode active material.

As used herein, “charging” and “to charge” refers to a process of providing electrochemical energy to a battery.

As used herein, “discharging” and “to discharge” refers to a process of removing electrochemical energy from a battery.

As used herein, “positive electrode” and “cathode” refer to an electrode at which electrochemical reduction and lithiation occur during a discharge process.

As used herein, “negative electrode” and “anode” refer to an electrode at which electrochemical oxidation and delithiation occur during a discharge process.

Although specific embodiments have been described, alternatives, modifications, variations, improvements, and substantial equivalents that may not currently be anticipated or foreseeable could arise for the applicant or those skilled in the art. Therefore, the appended claims, as filed and as amended, are intended to encompass all such alternatives, modifications, variations, improvements, and substantial equivalents.

Hereinafter, an all-solid secondary battery and a preparation method thereof according to embodiments are described in more detail.

### All-Solid Secondary Battery

An all-solid secondary battery according to an embodiment may include a laminate which may include a unit cell and a compression assistance layer on at least one side of the unit cell, where the unit cell may include an electrode assembly and an exterior material on the electrode assembly, where the electrode assembly may include a cathode layer, an anode layer and a solid electrolyte layer between the cathode layer and the anode layer. The compression assistance layer may be disposed, for example, on the upper surface, lower surface, or upper and lower surfaces of the unit cell.

When pressure is applied to a laminate including a compression assistance layer, the pressure applied to the laminate may be uniformly transmitted to the interior of the cathode layer. This effectively reduces voids between the cathode active material particles within the cathode layer. For example, by effectively transmitting the pressure applied to a solid electrolyte disposed between the cathode active material particles, pressure sintering of the solid electrolyte may be effectively performed. As a result, an all-solid secondary battery equipped with a laminate that includes a compression assistance layer may provide reduced internal resistance of the cathode layer and reduced porosity of the cathode layer. In contrast, when a laminate without a compression assistance layer is compressed, the pressure exerted on the laminate may primarily be transmitted to the cathode active material particles, which have relatively high strength and volume within the cathode layer. This can make it difficult to reduce the voids between the cathode active material particles within the cathode layer. As a result, an all-solid secondary battery that does not include a compression assistance layer may have difficulty providing reduced internal resistance of the cathode layer and reduced porosity of the cathode layer.

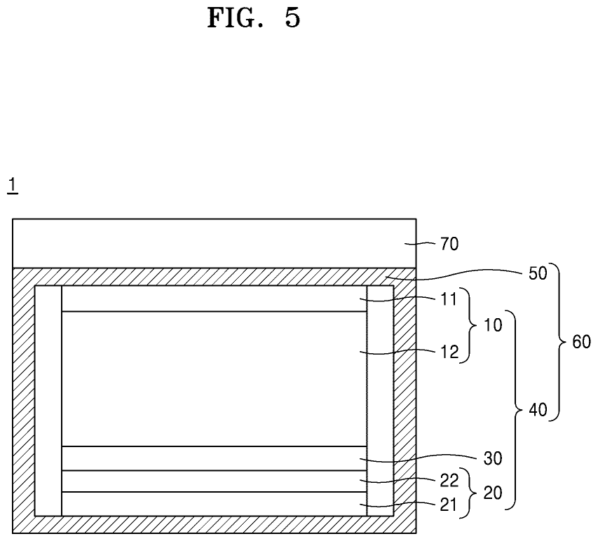

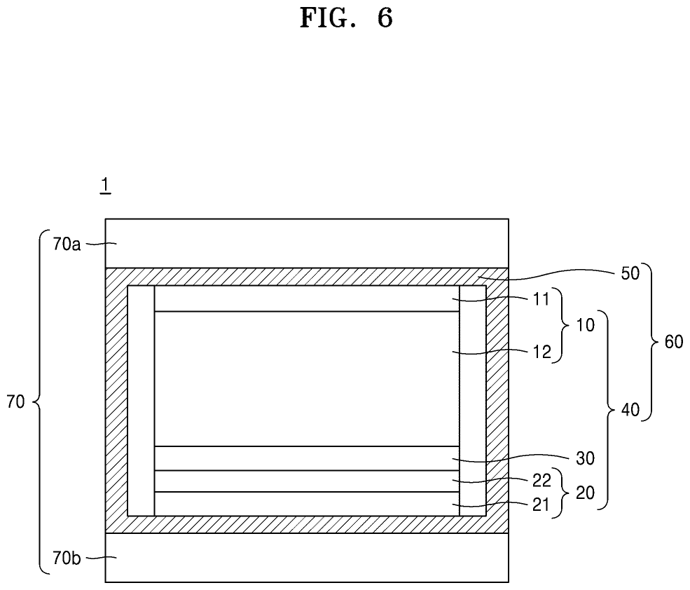

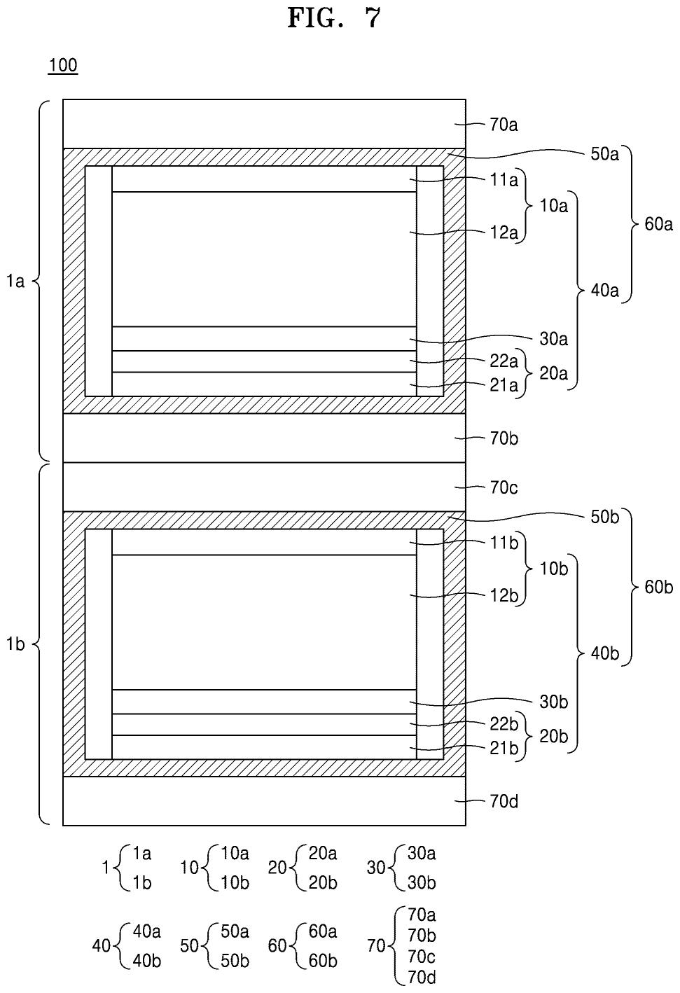

Referring to FIGS. 5 to 7, an all-solid secondary battery 1, 1a, 1b may include a unit cell 60, 60a, 60b, and a compression assistance layer 70, 70a, 70b, 70c, 70d on at least one side of the unit cell 60, 60a, 60b. The unit cell 60, 60a, 60b may include an electrode assembly 40, 40a, 40b, and an exterior material 50, 50a, 50b on the electrode assembly 40, 40a, 40b. An electrode assembly 40, 40a, 40b may include a cathode layer 10, 10a, 10b, an anode layer 20, 20a, 20b, and a solid electrolyte layer 30, 30a, 30b between the cathode layer 10, 10a, 10b and the anode layer 20, 20a, 20b. Referring to FIG. 7, a plurality of all-solid secondary batteries 1, 1a, 1b may be stacked in the thickness direction to form an all-solid secondary battery laminate 100.

### Compression Assistance Layer

Referring to FIGS. 5 to 7, an all-solid secondary battery 1, 1a, 1b may include a compression assistance layer 70, 70a, 70b, 70c, 70d. The buckling deformation point of the compression assistance layer 70, 70a, 70b, 70c, 70d may be 100 MPa or more. The buckling deformation point of the compression assistance layer 70, 70a, 70b, 70c, 70d may be 100 MPa or more, 200 MPa or more, 300 MPa or more, 400 MPa or more, or 500 MPa or more. The buckling deformation point of the compression assistance layer 70, 70a, 70b, 70c, 70d may be about 100 MPa to about 1000 MPa, about 200 MPa to about 1000 MPa, about 300 MPa to 1000 MPa, about 400 MPa to about 1000 MPa, or about 500 MPa to about 1000 MPa. By having a buckling deformation point within this range, the compression assistance layer 70, 70a, 70b, 70c, 70d may apply more uniform pressure to the cathode layer 10, 10a, 10b during compressing. By transmitting uniform pressure to the cathode layer 10, 10a, 10b, the internal resistance of the cathode layer 10, 10a, 10b may be further reduced and the porosity of the cathode layer 10, 10a, 10b may be further reduced. The cycle performance of an all-solid secondary battery including such a compression assistance layer 70, 70a, 70b, 70c, 70d may be improved.

The buckling deformation point refers to the point where the deformation of the specimen in the vertical direction caused by the compressive force does not recover even after the compressive force is removed. The buckling deformation point corresponds to the yielding point of the material when compressed. The buckling point represents, for example, the point where the material begins to undergo permanent deformation without retaining elasticity. If the buckling deformation point of the compression assistance layer 70, 70a, 70b, 70c, 70d is too low, the compression assistance layer may deform too easily under low pressure, making it difficult to apply uniform pressure to the cathode layer 10, 10a, 10b.

The Young's modulus of the compression assistance layer 70, 70a, 70b, 70c, 70d may be 600 MPa or more, 700 MPa or more, or 800 MPa or more. The Young's modulus of the compression assistance layer 70, 70a, 70b, 70c, 70d may be lower than the Young's modulus of the solid electrolyte. The Young's modulus of the compression assistance layer 70, 70a, 70b, 70c, 70d may be lower than the Young's modulus of the solid electrolyte in the cathode layer 10, 10a, 10b. The Young's modulus of a sulfide-containing solid electrolyte may be about 20 gigapascal (GPa). The Young's modulus of the compression assistance layer 70, 70a, 70b, 70c, 70d may be about 600 MPa to about 20 GPa, about 700 MPa to about 10 GPa, or about 800 MPa to about 5 GPa. The compression assistance layer 70, 70a, 70b, 70c, 70d may transmit uniform pressure to the cathode layer 10, 10a, 10b by having a Young's modulus with this ranges. By transmitting uniform pressure to the cathode layer 10, 10a, 10b, the internal resistance of the cathode layer 10, 10a, 10b may be further reduced and the porosity of the cathode layer 10, 10a, 10b may be further reduced. The cycle performance of all-solid secondary batteries may be improved.

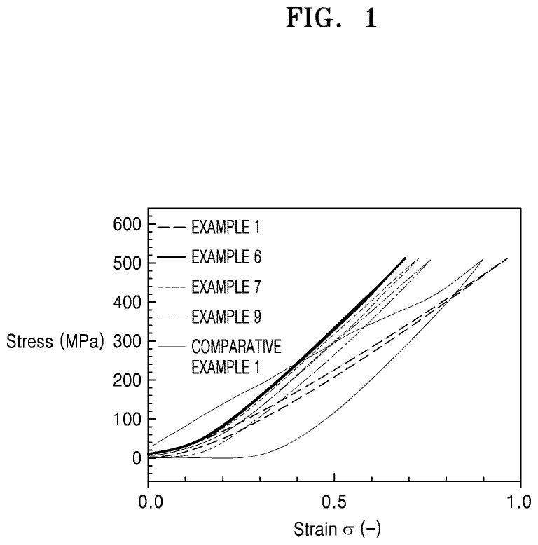

In a stress-strain curve of a compression-relaxation cycle including a compression process and a relaxation process for a compression assistance layer 70, 70a, 70b, 70c, 70d, a difference between a first stress corresponding to 50% strain of the compression assistance layer 70, 70a, 70b, 70c, 70d during the compression process and a second stress corresponding to 50% strain of the compression assistance layer 70, 70a, 70b, 70c, 70d during the relaxation process may be 50 MPa or less, 40 MPa or less, 30 MPa or less, 20 MPa or less, or 10 MPa or less. Referring to FIG. 1, the first stress may correspond to the stress at a strain of 50% during the compression process. The second stress may correspond to the stress at a strain of 50% during the relaxation process. By maintaining a difference of 50 MPa or less between the first stress and the second stress, uniform pressure may be transmitted to the cathode layer 10, 10a, 10b. By transmitting uniform pressure to the cathode layer 10, 10a, 10b, the internal resistance of the cathode layer 10, 10a, 10b may be further reduced and the porosity of the cathode layer 10, 10a, 10b may be further reduced. The cycle performance of all-solid secondary batteries may be improved.

The thickness of the compression assistance layer 70, 70a, 70b, 70c, 70d may be about 1 micrometer (μm) or more and about 1 mm or less, about 10 μm or more and about 1 mm or less, about 50 μm or more and about 1 mm or less, or about 100 μm or more and about 1 mm or less. The thickness of the compression assistance layer 70, 70a, 70b, 70c, 70d may be about 10 μm or more and about 1 mm or less, about 10 μm or more and about 900 μm or less, or about 50 μm or more and about 500 μm or less. The compression assistance layer 70, 70a, 70b, 70c, 70d may transmit uniform pressure to the cathode layer 10, 10a, 10b by having a Young's modulus within this range. By transmitting uniform pressure to the cathode layer 10, 10a, 10b, the internal resistance of the cathode layer 10, 10a, 10b may be further reduced and the porosity of the cathode layer 10, 10a, 10b may be further reduced. The cycle performance of all-solid secondary batteries may be improved. If the thickness of the compression assistance layer 70, 70a, 70b, 70c, 70d is too thin, it may be difficult to achieve the intended effect. If the thickness of the compression assistance layer 70, 70a, 70b, 70c, 70d is too thick, the energy density of the all-solid secondary battery may become excessively low.

The compression assistance layer 70, 70a, 70b, 70c, 70d may have a single-layer structure or a multi-layer structure. The multi-layer structure may have a two-layer, three-layer or four-layer structure. In a multi-layer structure, each layer may contain the same or different materials. One or more of the layers making up the single-layer structure or multi-layer structure may be an insulating layer. By including an insulating layer, the compression assistance layer 70, 70a, 70b, 70c, 70d may more effectively suppress short circuits of the all-solid secondary battery.

The compression assistance layer 70, 70a, 70b, 70c, 70d may be disposed adjacent to the cathode layer 10, 10a, 10b. The compression assistance layer 70, 70a, 70b, 70c, 70d may transmit uniform pressure to the cathode layer 10, 10a, 10b by being disposed adjacent to the cathode layer 10, 10a, 10b. By transmitting uniform pressure to the cathode layer 10, 10a, 10b, the internal resistance of the cathode layer 10, 10a, 10b may be further reduced and the porosity of the cathode layer 10, 10a, 10b may be further reduced. The cycle performance of all-solid secondary batteries may be improved.

The compression assistance layer 70, 70a, 70b, 70c, 70d may include a polymer, a metal, a wood, or a combination thereof. Examples of the polymer include polyimide (PI), polyethylene terephthalate (PET), polytetrafluoroethylene (PTFE), polystyrene (PS), polycarbonate (PC), polyvinyl chloride (PVC), polyvinyl alcohol, polyacrylate, polyethylene, polypropylene, polystyrene, polyisobutylene, polyvinyl chloride, vinyl acetate resin, polytetrafluoroethylene, polyacrylonitrile, polymethyl methacrylate, polyethylene terephthalate optionally blended with cotton or rayon, available under the trademark Tetoron®, nylon, a phenol-formaldehyde polymer, available, for example, under the trade name Bakelite, urea resin, polysiloxane, or a combination thereof. The metal may include a metal belonging to Groups 2 to 16 of the periodic table. The metal may include aluminum, copper, stainless steel (SUS), zinc, tin, lead, magnesium, titanium, nickel, or a combination thereof. The compression assistance layer 70, 70a, 70b, 70c, 70d may have a multi-layer structure including a polymer layer and a metal layer. The compression assistance layer 70, 70a, 70b, 70c, 70d may have a polymer layer/metal layer structure or a polymer layer/metal layer/polymer layer structure.

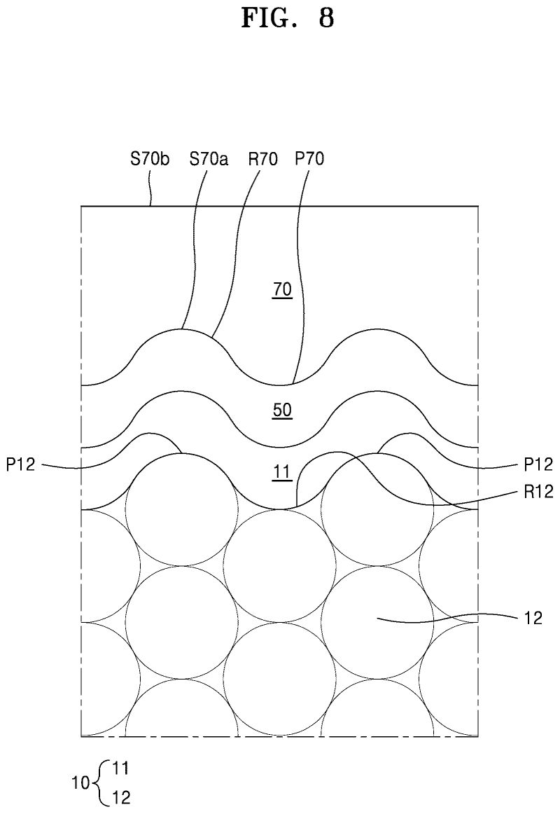

Referring to FIG. 5 and FIG. 8, the cathode layer 10, 10a, 10b may include a cathode current collector 11, 11a, 11b and a cathode active material layer 12, 12a, 12b.

Referring to FIG. 8, the compression assistance layer 70 may include one side, i.e., a first side S70a adjacent to the cathode active material layer 12, 12a, 12b, and another side, i.e., a second side S70b opposing the first side S70a. A first surface of the cathode active material layer 12, 12a, 12b adjacent to the compression assistance layer 70 may include a first protrusion P12 and a first recess R12. The first recess R12 may be disposed between a plurality of adjacent first protrusions P12s. The first protrusion P12 may be disposed between a plurality of adjacent first recesses R12s. The surface of the cathode active material layer 12, 12a, 12b may have a first surface outline. The first surface contour of the first surface of the cathode active material layer 12, 12a, 12b may include a first protrusion P12 and a first recess R12. The one side, i.e., first side S70a of the compression assistance layer may include a second recess R70 corresponding to a first protrusion P12 on the surface of the cathode active material layer 12, 12a, 12b, and a second protrusion P70 corresponding to a first recess R12 on the surface of the cathode active material layer 12, 12a, 12b. The compression assistance layer surface S70a may have a second surface contour. The second surface contour of the first side S70a of the compression assistance layer may include a second recess R70 and a second protrusion P70. The first surface contour of the surface of the cathode active material layer 12, 12a, 12b and the second surface contour of the first side S70a of the compression assistance layer may correspond to each other. The first surface contour of the first surface of the cathode active material layer 12, 12a, 12b and the second surface contour of the first side S70a of the compression assistance layer may correspond to each other, thereby enabling uniform pressure to be transmitted to the cathode layer 10. By transmitting uniform pressure to the cathode layer, the internal resistance of the cathode layer may be further reduced, and the porosity of the cathode layer may be further reduced. The cycle performance of all-solid secondary batteries may be improved. The first side S70a of the compression assistance layer may have a second surface contour, and the second side S70b of the compression assistance layer opposing the first side S70a of the compression assistance layer may have a third surface contour. The second surface contour of the first side S70a of the compression assistance layer may be distinguished from the third surface contour of the second side S70b of the compression assistance layer. The second surface contour of the first side S70a of the compression assistance layer may include a second recess R70 and a second protrusion P70. In contrast, the third surface contour of the second side S70b of the compression assistance layer may not include protrusions or recesses.

The surface roughness of the first side S70a of the compression assistance layer may be greater than the surface roughness of the second side S70b of the compression assistance layer. For example, the maximum roughness depth (Rₘₐₓ) of the first side S70a of the compression assistance layer may be greater than that of the second side S70b of the compression assistance layer. The ratio (1^{st} Rₘₐₓ/2^{nd} Rₘₐₓ) of a first maximum roughness depth (1^{st} Rₘₐₓ) of the first side S70a of the compression assistance layer to a second maximum roughness depth (2^{nd} Rₘₐₓ) of the second side S70b of the compression assistance layer may be 1.5 or more, 2 or more, 5 or more, or 10 or more. The maximum roughness depth of the first side S70a of the compression assistance layer may be 1 μm or more, 2 μm or more, 5 μm or more, or 10 μm or more. The maximum roughness depth of the first side S70a of the compression assistance layer may be about 1 μm to about 20 μm, about 2 μm to about 20 μm, about 5 μm to about 20 μm, or about 10 μm to about 20 μm.

For example, the mean roughness (Rₐ) of the first side S70a of the compression assistance layer may be greater than the mean roughness Rₐ of the second side S70b of the compression assistance layer. The ratio (1^{st} Rₐ/2^{nd} Rₐ) of a first mean roughness Rₐ (1^{st} Rₐ) of the first side S70a of the compression assistance layer and a second mean roughness Rₐ (2^{nd} Rₐ) of the second side S70b of the compression assistance layer may be 1.5 or more, 2 or more, 5 or more, or 10 or more. The mean roughness Rₐ of the first side S70a of the compression assistance layer may be 0.5 μm or more, 1 μm or more, 2 μm or more, or 3 μm or more. The mean roughness Rₐ of the first side S70a of the compression assistance layer may be about 0.1 μm to about 20 μm, about 0.5 μm to about 10 μm, about 1 μm to about 10 μm, about 2 μm to about 10 μm, or about 3 μm to about 10 μm.

For example, the root mean square (RMS) roughness (R_{q}) of the first side S70a of the compression assistance layer may be greater than the RMS roughness R_{q} of the second side S70b of the compression assistance layer. The ratio (1^{st} R_{q}/2^{nd} R_{q}) of a first RMS roughness (1^{st} R_{q}) of the first side S70a of the compression assistance layer and a second RMS roughness R_{q} (2^{nd} Rₐ) of the second side S70b of the compression assistance layer may be 1.5 or more, 2 or more, 5 or more, or 10 or more. The RMS roughness R_{q} of the first side S70a of the compression assistance layer may be 0.5 μm or more, 1 μm or more, 2 μm or more, or 3 μm or more. The RMS roughness R_{q} of the first side S70a of the compression assistance layer may be about 0.1 μm to about 20 μm, about 0.5 μm to about 10 μm, about 1 μm to about 10 μm, about 2 μm to about 10 μm, or about 3 μm to about 10 μm.

Referring to FIGS. 5 to 7, the compression assistance layer 70, 70a, 70b, 70c, 70d may be a non-porous layer. As used herein, a non-porous layer refers to a layer that does not contain pores intentionally introduced by a foaming agent or the like. The porosity due to pores unintentionally remaining in the compression assistance layer 70, 70a, 70b, 70c, 70d during the manufacturing process of the compression assistance layer 70, 70a, 70b, 70c, 70d may be 0.5 volume percent (vol %) or less or 0.1 vol % or less. The compression assistance layer 70, 70a, 70b, 70c, 70d may transmit uniform pressure to the cathode layer 10, 10a, 10b by being a non-porous layer. By transmitting uniform pressure to the cathode layer 10, 10a, 10b, the internal resistance of the cathode layer 10, 10a, 10b may be further reduced and the porosity of the cathode layer 10, 10a, 10b may be further reduced. The cycle performance of all-solid secondary batteries may be improved.

The compression assistance layer 70, 70a, 70b, 70c, 70d may be separated from the unit cells. The separation of the compression assistance layer 70, 70a, 70b, 70c, 70d may further enhance the energy density of the all-solid secondary battery.

### Unit Cell

Referring to FIGS. 5 to 7, a unit cell 60, 60a, 60b may include an electrode assembly 40, 40a, 40b, and an exterior material 50, 50a, 50b on the electrode assembly 40, 40a, 40b.

### Electrode Assembly

Referring to FIGS. 5 to 7, an electrode assembly 40, 40a, 40b may include a cathode layer 10, 10a, 10b, an anode layer 20, 20a, 20b, and a solid electrolyte layer 30, 30a, 30b between the cathode layer 10, 10a, 10b and the anode layer 20, 20a, 20b.

### Cathode Layer

### Cathode Layer: Cathode Active Material Layer

Referring to FIGS. 5 to 7, the cathode layer 10, 10a, 10b may include a cathode current collector 11, 11a, 11b and a cathode active material layer 12, 12a, 12b.

The first porosity of the cathode active material layer 12, 12a, 12b may be less than 8%, less than 7%, or less than 6%. A cathode active material layer 12, 12a, 12b having a first porosity within this range may further reduce the internal resistance of the cathode layer 10, 10a, 10b, and further reduce the first porosity of the cathode layer 10, 10a, 10b. The cycle performance of the all-solid secondary battery 1, 1a, 1b may be improved. The first porosity refers to the ratio of the area occupied by pores to the entire area of the cross-section of the cathode layer 10, 10a, 10b in a scanning electron microscope image of the cross-section of the cathode layer 10, 10a, 10b. The first porosity may be measured from the scanning electron microscope image of the cross-section of the cathode active material layer 12, 12a, 12b.

The cathode layer 10, 10a, 10b may include a cathode current collector and a cathode active material, and the cathode active material layer may have a second porosity of 14% or less, 10% or less, 8% or less, or 5% or less. A cathode active material layer 12, 12a, 12b having a second porosity within this range may further reduce the internal resistance of the cathode layer 10, 10a, 10b, and further reduce the second porosity of the cathode layer 10, 10a, 10b. The cycle performance of all-solid secondary batteries may be improved. The second porosity refers to the ratio of the area occupied by pores to the entire remaining area excluding the area of the cathode active material in the scanning electron microscope image of the cross-section of the cathode layer 10, 10a, 10b. The second porosity may be measured from a scanning electron microscope image of a cross-section of the cathode active material layer 12, 12a, 12b.

### Cathode Layer: Cathode Active Material

Referring to FIGS. 5 to 7, the cathode 10, 10a, 10b may include a cathode current collector 11, 11a, 11b and a cathode active material layer 12, 12a, 12b disposed on the cathode current collector. The cathode active material layer 12, 12a, 12b may contain a cathode active material.

The cathode active material may be a cathode active material that can reversibly absorb and desorb lithium ions. Examples of the cathode active material may include a lithium transition metal oxide such as lithium cobalt oxide (LCO), lithium nickel oxide, lithium nickel cobalt oxide, lithium nickel cobalt aluminum oxide (NCA), lithium nickel cobalt manganese oxide (NCM), lithium manganate or lithium iron phosphate; or vanadium oxide, but is not necessarily limited thereto and any material used as a cathode active material in the art may be used. The cathode active materials may be either singular or a combination of two or more types.

The lithium transition metal oxide may include compounds represented by any one of the following formulae: LiₐA_{1-b}B′_{b}D₂ (where 0.90≤a≤1, 0≤b≤0.5); LiₐE_{1-b}B′_{b}O_{2-c}D_{c} (where 0.90≤a≤1, 0≤b≤0.5, 0≤c≤0.05); LiE_{2-b}B′_{b}O_{4-c}D_{c} (where 0≤b≤0.5, 0≤c≤0.05); LiₐNi_{1-b-c}Co_{b}B′_{c}D_{α} (where 0.90≤a≤1, 0≤b≤0.5, 0≤c≤0.05, 0<α≤2); LiₐNi_{1-b-c}Co_{b}B′_{c}O₂₋ₐF′_{α} (where 0.90≤a≤1, 0≤b≤0.5, 0≤c≤0.05, 0<α<2); LiₐNi_{1-b-c}Mn_{b}B′_{c}D_{α} (where 0.90≤a≤1, 0≤b≤0.5, 0≤c≤0.05, 0<α<2); LiₐNi_{1-b-c}Mn_{b}B′_{c}O_{2-α}F′_{α} (where 0.90≤a≤1, 0≤b≤0.5, 0≤c≤0.05, 0<α<2); LiₐNi_{b}E_{c}G_{d}O₂ (where 0.90≤a≤1, 0≤b≤0.9, 0≤c≤0.5, 0.001≤d≤0.1.); LiₐNi_{b}Co_{c}Mn_{d}GeₑO₂ (where 0.90≤a≤1, 0≤b≤0.9, 0≤c≤0.5, 0≤d≤0.5, 0.001≤e≤0.1.); LiₐNiG_{b}O₂ (where 0.90≤a≤1, 0.001≤b≤0.1.); LiₐCoG_{b}O₂ (where 0.90≤a≤1, 0.001≤b≤0.1.); LiₐMnG_{b}O₂ (where 0.90≤a≤1, 0.001≤b≤0.1.); LiₐMn₂G_{b}O₄ (where 0.90≤a≤1, 0.001≤b≤0.1.); QO₂; QS₂; LiQS₂; V₂O₅; LiV₂O₅; LiI′O₂; LiNiVO₄; Li_{(3-f)}J₂(PO₄)₃ (0≤f≤2); Li_{(3-f)}Fe₂(PO₄)₃ (0≤f≤2); and LiFePO₄. In the above compounds, A is Ni, Co, Mn, or a combination thereof; B′ is Al, Ni, Co, Mn, Cr, Fe, Mg, Sr, V, a rare earth element, or a combination thereof; D is O, F, S, P, or a combination thereof; E is Co, Mn, or a combination thereof; F′ is F, S, P, or a combination thereof; G is Al, Cr, Mn, Fe, Mg, La, Ce, Sr, V, or a combination thereof; Q is Ti, Mo, Mn, or a combination thereof; I′ is Cr, V, Fe, Sc, Y, or a combination thereof; J is V, Cr, Mn, Co, Ni, Cu, or a combination thereof. It is also possible to use a compound having a coating layer added to the surface of such a compound, as well as a combination of the aforementioned compound and a compound having a coating layer added. The coating layer added to the surface of these compounds may include coating element compounds such as an oxide of the coating element, a hydroxide of the coating element, an oxyhydroxide of the coating element, an oxycarbonate of the coating element, or a hydroxycarbonate of the coating element. The compounds forming the coating layers may be amorphous or crystalline. The coating elements included in the coating layer may include Mg, Al, Co, K, Na, Ca, Si, Ti, V, Sn, Ge, Ga, B, As, Zr, or a combination thereof. The method of forming the coating layer may be within a range that does not adversely affect the properties of the cathode active material. Coating methods may include spray coating and dipping. Specific coating methods are well understood by those skilled in the art, therefore, a detailed explanation is omitted here.

The cathode active material may include a lithium transition metal oxide represented by the following Formulae 1 to 8:

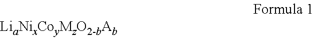

wherein in Formula 1,

$$1. \leq a \leq 1.2 , 0 \leq b \leq 0.2 , 0.8 \leq x < 1 , 0 \leq y \leq 0.3 , 0 < z \leq 0.3 , and x + y + z = 1 ;$$

M represents manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof,
A represents F, S, Cl, Br, or a combination thereof,

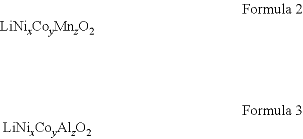

wherein in Formulae 2 to 3, 0.8≤x≤0.95, 0≤y≤0.2, 0<z≤0.2 and x+y+z=1,

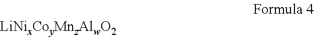

wherein in Formula 4, 0.8≤x≤0.95, 0≤y≤0.2, 0<z≤0.2, 0<w≤0.2, and x+y+z+w=1,

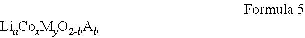

wherein in Formula 5,

$$1. \leq a \leq 1.2 , 0 \leq b \leq 0.2 , 0.9 \leq x \leq 1 , 0 \leq y \leq 0.1 , and x + y = 1 ,$$

M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof,
A represents F, S, Cl, Br, or a combination thereof,

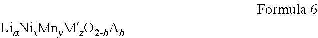

wherein in Formula 6,

$$1. \leq a \leq 1.2 , 0 \leq b \leq 0.2 , 0 < x \leq 0.3 , 0.5 \leq y < 1 , 0 < z \leq 0.3 , and x + y + z = 1 ,$$

M′ represents cobalt (Co), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, A represents F, S, Cl, Br, or a combination thereof,

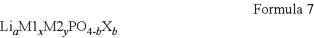

wherein in Formula 7,

$$0.9 \leq a \leq 1.1 , 0 \leq x \leq 0.9 , 0 \leq y \leq 0.5 , 0.9 < x + y < 1.1 , and 0 \leq b \leq 2 ,$$

M1 represents chromium (Cr), manganese (Mn), iron (Fe), cobalt (Co), nickel (Ni), copper (Cu), zirconium (Zr), or a combination thereof,
M2 represents magnesium (Mg), calcium (Ca), strontium (Sr), barium (Ba), titanium (Ti), zinc (Zn), boron (B), niobium (Nb), gallium (Ga), indium (In), molybdenum (Mo), tungsten (W), aluminum (Al), silicon (Si), chromium (Cr), vanadium (V), scandium (Sc), yttrium (Y) or a combination thereof, and X represents O, F, S, P or a combination thereof;

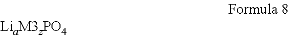

wherein in Formula 8,
0.90≤a≤1.1, and 0.9≤z≤1.1, and
M3 represents chromium (Cr), manganese (Mn), iron (Fe), cobalt (Co), nickel (Ni), copper (Cu), zirconium (Zr), or a combination thereof.

The oxide-containing cathode active material may be covered by a coating layer. The coating layer may be any one known as a coating layer of a cathode active material of an all-solid secondary battery. The coating layer may be Li₂O—ZrO₂ (LZO).

The size of the oxide-containing cathode active material may be about 0.1 μm to about 30 μm, about 0.5 μm to about 20 μm or about 1 μm to about 15 μm. The oxide-containing cathode active material may be a single crystal particle or a polycrystalline particle.

The shape of the cathode active material may be particle shapes such as true spherical or ellipsoidal spherical forms. The particle size of the cathode active material is not particularly limited and is within a range applicable to cathode active materials of conventional all-solid secondary batteries. The content of the cathode active material of the cathode layer 10, 10a, 10b is not particularly limited, and may be within a range applicable to the cathode layer 10, 10a, 10b of a conventional all-solid secondary battery. The content of the cathode active material included in the cathode active material layer 12, 12a, 12b may be about 80 weight percent (wt %) to about 99 wt %, about 80 wt % to about 95 wt %, or about 80 wt % to about 90 wt % of the total weight of the cathode active material layer 12, 12a, 12b.

### Cathode Layer: Solid Electrolyte

The cathode active material layer 12, 12a, 12b may further include a solid electrolyte. The solid electrolyte may be a sulfide-containing solid electrolyte. The solid electrolyte included in the cathode layer 10, 10a, 10b may be the same as or different from the solid electrolyte included in the solid electrolyte layer 30, 30a, 30b. For the detailed information on the solid electrolyte, the section on solid electrolyte layers 30, 30a, 30b is referred.

The solid electrolyte included in the cathode active material layer 12, 12a, 12b may have a smaller median particle diameter (D50 average particle size) compared to the solid electrolyte included in the solid electrolyte layer 30, 30a, 30b. For example, the D50 average particle size of the solid electrolyte in the cathode active material layer 12, 12a, 12b may be 90 percent or less, 80 percent or less, 70 percent or less, 60 percent or less, 50 percent or less, 40 percent or less, 30 percent or less, or 20 percent or less of the D50 average particle size of the solid electrolyte in the solid electrolyte layer 30, 30a, 30b. The D50 average particle size refers to the median particle diameter (D50). The median particle diameter (D50) refers to the particle size corresponding to 50 percent cumulative volume, calculated from the smaller particle size side in the particle size distribution measured by the laser diffraction method.

The solid electrolyte content included in the cathode active material layer 12, 12a, 12b may be about 1 wt % to about 40 wt %, about 1 wt % to about 30 wt %, about 1 wt % to about 20 wt %, or about 1 wt % to about 10 wt % of the total weight of the cathode active material layer 12, 12a, 12b.

### Cathode Layer: Conductive Material

The cathode active material layer 12, 12a, 12b may further include a conductive material. The conductive material may be a carbon-containing conductive material, a metal-containing conductive material, or a combination thereof. The carbon-containing conductive material may be, but is not limited to, graphite, carbon black, acetylene black, Ketjen black, carbon fiber, or a combination thereof, and any material used as a carbon-containing conductive material in the art may be used. The metal-containing conductive material may be, but is not limited to, metal powder, metal fiber, or a combination thereof, and any material used as a metal-containing conductive material in the art may be used. The conductive material content included in the cathode active material layer 12, 12a, 12b may be about 1 wt % to about 30 wt %, about 1 wt % to about 20 wt %, or about 1 wt % to about 10 wt % of the total weight of the cathode active material layer 12, 12a, 12b.

### Cathode Layer: Binder

The cathode active material layer 12, 12a, 12b may further include a binder. Examples of the binder include, but is not limited to, styrene butadiene rubber (SBR), polytetrafluoroethylene, polyvinylidene fluoride, and polyethylene, and any binder used in the art may be used. The binder content included in the cathode active material layer 12, 12a, 12b may be about 1 wt % to about 10 wt % of the total weight of the cathode active material layer 12, 12a, 12b. The binder may be optional.

### Cathode Layer: Other Additives

The cathode active material layer 12, 12a, 12b may further include additives such as fillers, coating agents, dispersants, and ionic conductive assistants in addition to the aforementioned cathode active material, solid electrolyte, binder, and conductive material.

As fillers, known materials typically used in electrodes of all-solid secondary batteries, for example, such as coating agents, dispersants, ionic conductive assistants, and the like that can be included in the cathode active material layer 12, 12a, 12b may be used.

### Cathode Layer: Cathode Current Collector

The cathode current collector 11, 11a, 11b may use a plate or foil made of, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof. The cathode current collector 11 may be omitted. The thickness of the cathode current collector 11, 11a, 11b may be about 1 μm to about 100 μm, about 1 μm to about 50 μm, about 5 μm to about 25 μm, or about 10 μm to about 20 μm.

The cathode current collector 11, 11a, 11b may include a base film and a metal layer disposed on one or both sides of the base film. The base film may include a polymer. The polymer may be a thermoplastic polymer. Examples of the polymer may include polyethylene terephthalate (PET), polyethylene (PE), polypropylene (PP), polybutylene terephthalate (PBT), polyimide (PI), or a combination thereof. The base film may be an insulator. By including an insulating thermoplastic polymer, the base film may soften or liquefy in the event of short circuits, shutting down battery operation and suppressing a sudden increase in current. The metal layer may include indium (In), copper (Cu), magnesium (Mg), stainless steel, titanium (Ti), iron (Fe), cobalt (Co), nickel (Ni), zinc (Zn), aluminum (Al), germanium (Ge), or an alloy thereof. The metal layer may act as an electrochemical fuse, disconnecting during overcurrent to prevent short circuits. The threshold current and the maximum current may be adjusted by controlling the thickness of the metal layer. The metal layer may be plated or deposited onto the base film. As the thickness of the metal layer decreases, the threshold and/or maximum current of the cathode current collector 11, 11a, 11b decrease, improving the stability of the lithium battery during short circuits. A lead tab may be added to the metal layer for external connection. The lead tab may be welded to the metal layer or the metal layer/base film laminate using ultrasonic welding, laser welding, spot welding, or the like. During welding, the base film and/or the metal layer may melt, allowing the metal layer to be electrically connected to the lead tab. To enhance the weld between the metal layer and the lead tab, a metal chip may be added between them. The metal chip may be a thin piece made of the same material as the metal in the metal layer. The metal chip may be a metal foil or a metal mesh. The metal chip may be an aluminum foil, copper foil, or SUS foil. By placing a metal chip on a metal layer and then welding it with a lead tab, the lead tab may be welded to a metal chip/metal layer laminate or a metal chip/metal layer/base film laminate. During welding, the base film, metal layer, and/or metal chip may melt, enabling the metal layer or the metal chip/metal layer laminate to be electrically connected to the lead tab. Metal chips and/or lead tabs may be added to a portion of the metal layer. The thickness of the base film may be about 1 μm to about 50 μm, about 1.5 μm to about 50 μm, about 1.5 μm to about 40 μm, or about 1 μm to about 30 μm. A base film within this thickness range may more effectively reduce the weight of the electrode assembly 40, 40a, 40b. The melting point of the base film may range from about 100° C. to about 300° C., from about 100° C. to about 250° C., or from about 100° C. to about 200° C. A base film with a melting point in this range may melt during the lead tab welding process, allowing the lead tab to bond easily. To improve the adhesion between the base film and the metal layer, surface treatment, such as corona treatment, may be performed on the base film. The thickness of the metal layer may be about 0.01 μm to about 3 μm, about 0.1 μm to about 3 μm, about 0.1 μm to about 2 μm or about 0.1 μm to 1 μm. A metal layer with a thickness in this range may maintain conductivity while ensuring the stability of the electrode assembly 40, 40a, 40b. The thickness of the metal chips may be about 2 μm to about 10 μm, about 2 μm to about 7 μm, or about 4 μm to about 6 μm. A metal chip within this thickness range may facilitate easier connection between the metal layer and the lead tab. By incorporating such a structure, the cathode current collector 11, 11a, 11b may reduce the weight of the cathode, thereby improving the energy density of the cathode and the all-solid secondary battery.

### Anode Layer

### Anode Layer: Anode Active Material

Referring to FIGS. 5 to 7, an anode layer 20, 20a, 20b may include an anode current collector 11 and a first anode active material layer 22, 22a, 22b. The first anode active material layer 22, 22a, 22b may include an anode active material.

The anode active material may have a particle form. The particle size of the anode active material may be less than 1 μm, 500 nm or less, 300 nm or less, or 100 nm or less. The particle size of the anode active material may be about 10 nm to less than about 1 μm, about 10 nm to about 900 nm, about 10 nm to about 700 nm, about 10 nm to about 500 nm, about 10 nm to about 300 nm, about 10 nm to about 200 nm or about 10 nm to about 100 nm. By having a particle size within this range, the anode active material may more easily perform reversible absorption and/or desorption of lithium during charge-discharge. The particle size of the anode active material may be the average particle size of the anode active material. The average particle size of the anode active material may be the median particle diameter (D50) measured using a laser particle size distribution meter. Alternatively, the particle size of the anode active material may be measured by scanning electron microscope.

The aspect ratio of the anode active material may be 5 or less, 4 or less, 3 or less, or 2 or less. The aspect ratio of the anode active material may be about 1 to about 5, about 1 to about 4, about 1 to about 3 or about 1 to about 2. By having an aspect ratio within this range, the anode active material may be distributed more uniformly within the first anode active material layer 22, 22a, 22b. Uneven volume changes during charge-discharge of the anode active material may be suppressed. The aspect ratio of the anode active material may be measured using a scanning electron microscope. An anode active material with an aspect ratio in this range may further improve the high-rate performance of an all-solid secondary battery including the anode active material.

The anode active material may include a metal-containing anode active material, a carbon-containing anode active material, or a combination thereof.

The metal-containing anode active material may include a metal capable of forming an alloy with lithium or a metal capable of forming a compound with lithium. The metal-containing anode active material may include zinc (Zn), gold (Au), platinum (Pt), palladium (Pd), silicon (Si), silver (Ag), aluminum (Al), bismuth (Bi), tin (Sn), iridium (Ir), osmium (Os), rhodium (Rh), ruthenium (Ru), or a combination thereof. For example, nickel (Ni) does not form an alloy with lithium and therefore does not belong to the metal-containing anode active material.

Carbon-containing anode materials may include amorphous carbon, crystalline carbon, porous carbon, or a combination thereof. Carbon-containing anode materials may be amorphous carbon. Amorphous carbon may include carbon black (CB), acetylene black (AB), furnace black (FB), ketjen black (KB), graphene, or a combination thereof. Amorphous carbon is carbon that has no crystallinity or very low crystallinity, and is distinguished from crystalline carbon or graphitic carbon. The degree of crystallinity of carbon-containing anode materials may be calculated from the x-ray diffraction (XRD) spectrum of the carbon-containing material as a percentage of the intensity of peaks attributable to crystalline carbon (I_{crystalline}) and amorphous carbon (Iₐₘₒᵣₚₕₒᵤₛ). Lower percentages indicate lower crystallinity. The carbon-containing anode material may be porous carbon. Porous carbon may have a pore volume ranging from about 0.1 cubic centimeters per gram (cc/g) to about 10.0 cc/g, about 0.5 cc/g to about 5 cc/g, or about 0.1 cc/g to about 1 cc/g. The average pore diameter of the porous carbon may range from about 1 nanometer (nm) to about 50 nm, about 1 nm to about 30 nm, or about 1 nm to about 10 nm. The BET surface area of porous carbon may range from about 100 square meters per gram (m²/g) to about 3000 m²/g. The average pore size and BET specific surface area of porous carbon may be measured by nitrogen gas adsorption method.

The first anode active material layer 22, 22a, 22b may include a kind of second anode active material among these anode active materials, or may include a combination of a plurality of different anode active materials. The first anode active material layer 22, 22a, 22b may include only amorphous carbon. Alternatively, the first anode active material layer 22, 22a, 22b may include zinc (Zn), gold (Au), platinum (Pt), palladium (Pd), silicon (Si), silver (Ag), aluminum (Al), bismuth (Bi), tin (Sn), iridium (Ir), osmium (Os), rhodium (Rh), ruthenium (Ru), or a combination thereof. Alternatively, the first anode active material layer 22, 22a, 22b may include a combination of amorphous carbon; and zinc (Zn), gold (Au), platinum (Pt), palladium (Pd), silicon (Si), silver (Ag), aluminum (Al), bismuth (Bi), tin (Sn), iridium (Ir), osmium (Os), rhodium (Rh), ruthenium (Ru), or a combination thereof. The weight ratio of the combination of a carbon-containing anode active material, such as amorphous carbon, and a metal-containing anode active material, such as zinc, may be about 99:1 to about 1:99, about 10:1 to about 1:2, about 5:1 to about 1:1, or about 4:1 to about 2:1. The anode active material having such a composition may enhance the high-rate performance of the all-solid secondary battery 1.

The first anode active material layer 22, 22a, 22b may include an anode active material, and the anode active material may include a combination of first particles made of amorphous carbon and second particles made of a metal-containing anode active material. Examples of the metal-containing anode active materials include gold (Au), platinum (Pt), palladium (Pd), silver (Ag), aluminum (Al), bismuth (Bi), tin (Sn), and zinc (Zn). The content of the second particles is about 1 wt % to about 60 wt %, about 8 wt % to about 60 wt %, about 10 wt % to about 50 wt %, about 15 wt % to about 40 wt %, or about 20 wt % to about 30 wt %, based on the total weight of the combination of the first particles and the second particles. A content of the second particles within this range may further enhance the cycle performance of an all-solid secondary battery.

### Anode Layer: Binder

The first anode active material layer 22, 22a, 22b may include a binder. The binder may be a polymer binder. Examples of the polymer binder included in the first anode active material layer 22, 22a, 22b may include styrene-butadiene rubber (SBR), polytetrafluoroethylene, polyvinylidene fluoride, polyethylene, vinylidene fluoride/hexafluoropropylene copolymer, polyacrylonitrile, and polymethyl methacrylate, but are not necessarily limited thereto, and any binder used in the art may be used. The binder may be composed of a single or a plurality of different binders. The polymer binder may include a fluorine-containing binder.

By including a binder, the first anode active material layer 22, 22a, 22b may be stabilized on the anode current collector 21, 21a, 21b. In addition, cracking of the first anode active material layer 22, 22a, 22b may be suppressed despite volume changes and/or relative position shifts of the first anode active material layer 22, 22a, 22b during charge-discharge process. For example, if the first anode active material layer 22, 22a, 22b does not include a binder, the first anode active material layer 22, 22a, 22b may easily separate from the anode current collector 21, 21a, 21b. As the first anode active material layer 22, 22a, 22b is detached from the anode current collector 21, 21a, 21b, the possibility of a short circuit occurring increases at the exposed portion of the anode current collector 21, 21a, 21b, as the anode current collector 21, 21a, 21b comes into contact with the solid electrolyte layer 30, 30a, 30b. The first anode active material layer 22, 22a, 22b may be manufactured by applying a slurry containing the materials constituting the first anode active material layer 22, 22a, 22b dispersed therein onto an anode current collector 21, 21a, 21b, and then drying it. By including a binder in the first anode active material layer 22, 22a, 22b, stable dispersion of the anode active material and fibrous carbon-containing material in the slurry may be possible. For example, when applying the slurry onto the anode current collector 21, 21a, 21b by screen printing, it is possible to suppress clogging of the screen (e.g., clogging by aggregates of the anode active material).

The binder content may be about 0.1 parts by weight to about 20 parts by weight, about 0.1 parts by weight to about 15 parts by weight, about 1 parts by weight to about 10 parts by weight, or about 5 parts by weight to about 10 parts by weight with respect to 100 parts by weight of the anode active material. By having a binder content in this range, the high-rate performance of the all-solid secondary battery 1 may be further improved.

### Anode Layer: Other Additives

The first anode active material layer 22, 22a, 22b may further include additives used in a conventional all-solid secondary battery 1, such as fillers, coating agents, dispersants, and ion conductive assistants.

### Anode Layer: First Anode Active Material Layer

The ratio (B/A) of the initial charge capacity (B) of the first anode active material layer 22, 22a, 22b to the initial charge capacity (A) of the cathode active material layer 12, 12a, 12b may be about 0.001 to about 0.45, about 0.005 to about 0.4, about 0.01 to about 0.3, about 0.01 to about 0.2, or about 0.01 to about 0.1. The initial charge capacity of the cathode active material layer 12, 12a, 12b is determined by charging from the first open circuit voltage to the maximum charging voltage with respect to Li/Li+. The initial charge capacity of the first anode active material layer 22, 22a, 22b is determined by charging from the second open circuit voltage to 0.01 volt (V) with respect to Li/Li+. The maximum charging voltage depends on the type of cathode material. The maximum charge voltage may be 1.5 V, 2.0 V, 2.5 V, 3.0 V, 3.5 V, 4.0 V, 4.2 V, or 4.3 V. For example, the maximum charge voltage of Li₂S or Li₂S composite may be determined between about 2.5 V and about 3.0 V with respect to Li/Li⁺. For example, the maximum charge voltage of a lithium transition metal oxide may be determined between about 3.0 V and about 4.5 V with respect to Li/Li⁺.

The initial charge capacity (mAh) of the cathode active material layer 12, 12a, 12b is calculated by multiplying the charge specific capacity (mAh/g) of the cathode active material by the mass (g) of the cathode active material in the cathode active material layer 12, 12a, 12b. If multiple types of cathode active materials are used, the charge specific capacity x mass is calculated for each cathode active material, and the sum of these values is the initial charge capacity of the cathode active material layer 12, 12a, 12b. The initial charge capacity of the first anode active material layer 22, 22a, 22b is also calculated in the same way. The initial charge capacity of the first anode active material layer 22, 22a, 22b is obtained by multiplying the charge capacity density (mAh/g) of the anode active material by the mass of the anode active material in the first anode active material layer 22, 22a, 22b. If multiple types of anode active materials are used, the charge capacity density x mass value is calculated for each anode active material, and the sum of these values is the initial charge capacity of the first anode active material layer 22, 22a, 22b. The charge capacity density of each of cathode active material and anode active material may be measured using an all-solid half-cell with lithium metal as a counter electrode. The initial charge capacities of each of the cathode active material layer 12, 12a, 12b and the first anode active material layer 22, 22a, 22b may be directly measured using an all-solid half-cell at a constant current density, for example, 0.1 mA/cm². For the cathode, the measurements may be performed for an operating voltage from the first open circuit voltage (OCV) to a maximum charge voltage, for example, 3.0 V with respect to Li/Li⁺. For the anode, the measurements may be performed for an operating voltage from the second open circuit voltage (OCV) to 0.01 V with respect to anode, for example lithium metal. For example, an all-solid half-cell having a cathode active material layer may be charged from a first open circuit voltage to 3.0 V at a constant current of 0.1 milliampere per square centimeter (mA/cm²). An all-solid half-cell having a first anode active material layer may be charged from a second open circuit voltage to 0.01 V with a constant current of 0.1 mA/cm². The current density during constant current charging may be 0.2 mA/cm², or 0.5 mA/cm². An all-solid half-cell having a cathode active material layer may be charged from a first open circuit voltage to 2.5 V, 2.0 V, 3.5 V, 4.0 V or 4.5 V. The maximum charge voltage of the cathode active material layer may be determined by the maximum voltage of the battery satisfying the safety conditions according to JISC8712:2015 of the Japanese Standards Association.

If the initial charge capacity of the first anode active material layer 22, 22a, 22b is too small, the thickness of the first anode active material layer 22, 22a, 22b becomes very thin, so that lithium dendrites formed between the first anode active material layer 22, 22a, 22b and the anode current collector 21, 21a, 21b during repeated charge-discharge processes may collapse the first anode active material layer 22, 22a, 22b, making it difficult to improve the cycle performance of the all-solid secondary battery 1. If the charge capacity of the first anode active material layer 22, 22a, 22b increases excessively, the energy density of the all-solid secondary battery 1 decreases and the internal resistance of the all-solid secondary battery 1 due to the first anode active material layer 22, 22a, 22b increases, making it difficult to improve the cycle performance of the all-solid secondary battery 1.

The thickness of the first anode active material layer 22, 22a, 22b may be 50% or less, 40% or less, 30% or less, 20% or less, or 10% or less of the thickness of the cathode active material layer 12, 12a, 12b. The thickness of the first anode active material layer 22, 22a, 22b may be about 1% to about 50%, about 1% to about 40%, about 1% to about 30%, about 1% to about 20%, or about 1% to about 10% of the thickness of the cathode active material layer 12, 12a, 12b. The thickness of the first anode active material layer 22, 22a, 22b may be about 1 μm to about 50 μm, about 2 μm to about 40 μm, about 3 μm to about 30 μm, about 4 μm to about 20 μm or about 5 μm to about 20 μm. If the thickness of the first anode active material layer 22, 22a, 22b is too thin, lithium dendrites formed between the first anode active material layer 22, 22a, 22b and the anode current collector 21, 21a, 21b may cause the first anode active material layer 22, 22a, 22b to collapse, making it difficult to improve the cycle performance of the all-solid secondary battery 1. If the thickness of the first anode active material layer 22, 22a, 22b increases excessively, the energy density of the all-solid secondary battery 1 decreases and the internal resistance of the all-solid secondary battery 1 due to the first anode active material layer 22, 22a, 22b increases, making it difficult to improve the cycle performance of the all-solid secondary battery 1. If the thickness of the first anode active material layer 22, 22a, 22b decreases, the initial charge capacity of the first anode active material layer 22, 22a, 22b also decreases.

### Anode Layer: Second Anode Active Material Layer

Although not shown in the drawing, the all-solid secondary battery 1 may further include a second anode active material layer disposed between the anode current collector 21, 21a, 21b and the first anode active material layer 22, 22a, 22b, after being charged. The second anode active material layer may be a metal layer containing lithium or a lithium alloy. In this way, the second anode active material layer containing lithium or a lithium alloy acts as a lithium reservoir. The lithium alloy may include, but is not limited to, a Li—Al alloy, a Li—Sn alloy, a Li—In alloy, a Li—Ag alloy, a Li—Au alloy, a Li—Zn alloy, a Li—Ge alloy, or a Li—Si alloy, and any lithium alloy used in the art is applicable. The second anode active material layer may be composed of one of these alloys, or of lithium, or may be composed of several types of alloys. The second anode active material layer may be, for example, a plated layer. The second anode active material layer may be precipitated between the first anode active material layer 22, 22a, 22b and the anode current collector 21, 21a, 21b, for example, during the charge process of an all-solid secondary battery 1.

The thickness of the second anode active material layer is not particularly limited, but may be about 1 μm to about 200 μm, about 1 μm to about 150 μm, about 1 μm to about 100 μm, about 1 μm to about 50 μm, about 1 μm to about 30 μm, about 1 μm to about 22 μm or about 1 μm to about 10 μm. If the thickness of the second anode active material layer is too thin, it is difficult for the second anode active material layer to perform the role of a lithium reservoir. If the thickness of the second anode active material layer is too thick, the mass and volume of the all-solid secondary battery 1 may increase, and the cycle performance of the all-solid secondary battery 1 may rather deteriorate.

The thickness of the second anode active material layer may be smaller than the thickness of the first anode active material layer 22, 22a, 22b. The thickness of the second anode active material layer may be 70% or less, 60% or less, 50% or less, 40% or less, or 30% or less of the thickness of the first anode active material layer 22, 22a, 22b. The thickness of the second anode active material layer may be about 1% to about 70%, about 1% to about 60%, about 1% to about 50%, about 1% to about 40%, or about 1% to about 30% of the thickness of the first anode active material layer 22, 22a, 22b. By reducing the thickness of the second anode active material layer compared to the thickness of the first anode active material layer 22, 22a, 22b, volume changes during charge-discharge of the all-solid secondary battery may be suppressed. As a result, deterioration may be suppressed by volume change of the all-solid secondary battery.

Alternatively, in an all-solid secondary battery 1, the second anode active material layer may be disposed between the anode current collector 21, 21a, 21b and the first anode active material layer 22, 22a, 22b, prior to the assembly of the all-solid secondary battery 1. When a second anode active material layer is disposed between the anode current collector 21, 21a, 21b and the first anode active material layer 22, 22a, 22b before assembling the all-solid secondary battery 1, the second anode active material layer may be a metal layer containing lithium or a lithium alloy and thus functions as a lithium reservoir. For example, before assembling the all-solid secondary battery 1, a lithium foil may be placed between the anode current collector 21, 21a, 21b and the first anode active material layer 22, 22a, 22b.

When the second anode active material layer is precipitated by charging after assembling the all-solid secondary battery 1, the second anode active material layer may not be included during the assembling of the all-solid secondary battery 1. As a result, the energy density of the all-solid secondary battery 1 may increase. During charging an all-solid secondary battery 1, the first anode active material layer 22, 22a, 22b may be charged beyond its capacity. That is, the first anode active material layer 22, 22a, 22b may be overcharged. During the initial charging, lithium may be absorbed into the first anode active material layer 22, 22a, 22b. The anode active material included in the first anode active material layer 22, 22a, 22b may form an alloy or a compound with the lithium ions that have moved from the cathode 10. When charging exceeds the capacity of the first anode active material layer 22, 22a, 22b, lithium may be precipitated at the rear side of the first anode active material layer 22, 22a, 22b, that is, between the anode current collector 21, 21a, 21b and the first anode active material layer 22, 22a, 22b. A metal layer corresponding to the second anode active material layer may be formed by the precipitated lithium. The second anode active material layer may be a metal layer mainly composed of lithium (i.e., metallic lithium). This outcome may be achieved, by including in the first anode active material layer 22, 22a, 22b, an anode active material that forms an alloy or compound with lithium. During discharge, lithium in the first anode active material layer 22, 22a, 22b and the second anode active material layer, i.e., the metal layer, may be ionized and move toward the cathode 10. Therefore, it is possible to use lithium as an anode active material in an all-solid secondary battery 1. In addition, since the first anode active material layer 22, 22a, 22b covers the second anode active material layer, it may act as a protective layer for the second anode active material layer, i.e., the metal layer, and at the same time, it may suppress the precipitation and growth of lithium dendrites. Therefore, short circuits and capacity reduction of the all-solid secondary battery 1 may be suppressed. As a result, the cycle performance of the all-solid secondary battery 1 may be improved. In addition, when the second anode active material layer is disposed by charging after assembling the all-solid secondary battery 1, the anode 20, i.e., the anode current collector 21, 21a, 21b and the first anode active material layer 22, 22a, 22b and the region therebetween may be Li-free regions that do not contain lithium (Li) in the initial state or the state after complete discharge of the all-solid secondary battery 1.

### Anode Layer: Anode Current Collector

The anode current collector 21, 21a, 21b may be composed of a material that does not react with lithium, i.e., does not form an alloy or compound. The materials constituting the anode current collector 21, 21a, 21b may include copper (Cu), stainless steel, titanium (Ti), iron (Fe), cobalt (Co), and nickel (Ni), but are not necessarily limited thereto, and any material that can be used as an electrode collector in the art may be used. The anode current collector 21, 21a, 21b may be composed of one of the aforementioned metals, or may be composed of an alloy or coating material of two or more metals. The anode current collector 21, 21a, 21b may be in the form of a plate or foil.

Although not shown in the drawing, the all-solid secondary battery 1 may further include a thin film containing an element capable of forming an alloy with lithium on one side of the anode current collector 21, 21a, 21b. The thin film may be disposed between the anode current collector 21, 21a, 21b and the first anode active material layer 22, 22a, 22b. The thin film may include elements capable of forming an alloy with lithium. Elements capable of forming an alloy with lithium include, but are not necessarily limited to, gold, silver, zinc, tin, indium, silicon, aluminum, and bismuth, and any element capable of forming an alloy with lithium in the art may be used. The thin film may be composed of one of these metals or of an alloy of multiple metals. When this thin film is disposed on one side of the anode current collector 21, 21a, 21b, the precipitation morphology of the second anode active material layer 23, which precipitates between the thin film and the first anode active material layer 22, 22a, 22b, may become more uniform, improving the cycle performance of the all-solid secondary battery 1. The thickness of the thin film may be about 1 nm to about 800 nm, about 10 nm to about 700 nm, about 50 nm to about 600 nm, or about 100 nm to about 500 nm. If the thickness of the thin film is less than 1 nm, it may be difficult for the thin film to perform its function. If the thickness of the thin film is too thick, the thin film itself absorbs lithium, which reduces the amount of lithium precipitation from the anode, lowering the energy density of the all-solid battery and deteriorating the cycle performance of the all-solid secondary battery 1. The thin film may be formed on the anode current collector 21, 21a, 21b by, for example, a vacuum deposition method, a sputtering method, a plating method, and so forth, but is not necessarily limited to these methods, and any method capable of forming a thin film in the art is possible.

Although not shown in the drawing, the anode current collector 21, 21a, 21b may include a base film and a metal layer disposed on one or both sides of the base film. The base film may include, for example, a polymer. The polymer may be a thermoplastic polymer. The polymer may include polyethylene terephthalate (PET), polyethylene (PE), polypropylene (PP), polybutylene terephthalate (PBT), polyimide (PI), or a combination thereof. The polymer may be an insulating polymer. By including an insulating thermoplastic polymer, the base film may soften or liquefy in the event of short circuits, shutting down battery operation and preventing a sudden current surge. The metal layer may include copper (Cu), stainless steel, titanium (Ti), iron (Fe), cobalt (Co), nickel (Ni), or an alloy thereof. The anode current collector 21, 21a, 21b may additionally include a metal chip and/or a lead tab. For more specific details on the base film, metal layer, metal chip, and lead tab of the anode current collector 21, 21a, 21b, the cathode current collector 11, 11a, 11b described above is referred. By adopting this structure, the anode current collector 21, 21a, 21b may reduce the weight of the anode, thereby enhancing the energy density of both the anode and the lithium battery.

### Solid Electrolyte Layer

### Solid Electrolyte Layer: Solid Electrolyte

Referring to FIGS. 5 to 7, the solid electrolyte layer 30, 30a, 30b may include a solid electrolyte layer 30, 30a, 30b disposed between the cathode layer 10, 10a, 10b and the anode layer 20, 20a, 20b. The solid electrolyte layer 30, 30a, 30b may include a solid electrolyte or a combination of a solid electrolyte and a gel electrolyte.

The solid electrolyte may include a sulfide-containing solid electrolyte, an oxide-containing solid electrolyte, a polymer solid electrolyte, or a combination thereof.

The solid electrolyte may be a sulfide-containing solid electrolyte. The sulfide-containing solid electrolyte may include one or more of Li₂S—P₂S₅, Li₂S—P₂S₅—LiX (X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive numbers, and Z is one of Ge, Zn, or Ga), Li₂S—GeS₂, Li₂S—SiS₂—Li₃PO₄, Li₂S—SiS₂-LiₚMO_{q} (p and q are positive numbers, and M is one of P, Si, Ge, B, Al, Ga, or In), Li₇₋ₓPS₆₋ₓClₓ (0≤x≤2), Li₇₋ₓPS₆₋ₓBrₓ (0≤x≤2), or Li₇₋ₓPS₆₋ₓIₓ (0≤x≤2). Sulfide-containing solid electrolytes are produced by processing starting materials such as Li₂S and P₂S₅ using a melting and rapid cooling method or mechanical milling method. Additionally, heat treatment may be performed after this treatment. The solid electrolytes may be amorphous, crystalline, or a combination of both. Additionally, the solid electrolyte may include sulfur(S), phosphorus (P), and lithium (Li) as constituent elements among the aforementioned sulfide-containing solid electrolyte materials. For example, the solid electrolyte may be a material containing Li₂S—P₂S₅. When using Li₂S—P₂S₅ as the material for forming a sulfide-containing solid electrolyte, the mixing molar ratio of Li₂S to P₂S₅ may be in the range of Li₂S:P₂S₅=about 20:80 to about 90:10, about 25:75 to about 90:10, about 30:70 to about 70:30, or about 40:60 to about 60:40.

The sulfide-containing solid electrolyte may include an argyrodite type solid electrolyte represented by the following Formula A:

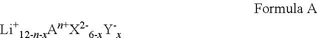

wherein A is P, As, Ge, Ga, Sb, Si, Sn, Al, In, Ti, V, Nb, or Ta; X is S, Se, or Te; Y is Cl, Br, I, F, CN, OCN, SCN, or N₃; 1≤n≤5 and 0≤x≤2. The sulfide-containing solid electrolyte may be an argyrodite-type compound including one or more of Li₇₋ₓPS₆₋ₓClₓ (0≤x≤2), Li_{7-X}PS₆₋ₓBrₓ (0≤x≤2), or Li₇₋ₓPS₆₋ₓIₓ (0≤x≤2). The sulfide-containing solid electrolyte may be an argyrodite-type compound including one or more of Li₆PS₅Cl, Li₆PS₅Br, or Li₆PS₅I.

The density of the argyrodite-type solid electrolyte may range from about 1.5 grams per cubic centimeter (g/cc) to about 2.0 g/cc. By having a density of 1.5 g/cc or higher, the argyrodite-type solid electrolyte reduces the internal resistance of the all-solid secondary battery and effectively suppresses penetration of the solid electrolyte layer by lithium (Li).

Oxide-containing solid electrolytes may include Li_{1+x+y}AlₓTi₂₋ₓSi_{y}P_{3-y}O₁₂ (0<x<2, 0≤y<3), BaTiO₃, Pb(Zr,Ti)O₃(PZT), Pb₁₋ₓLaₓZr_{1-y}Ti_{y}O₃ (PLZT) (0≤x<1, 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (0<x<2, 0<y<3), LiₓAl_{y}Ti_{z} (PO₄)₃ (0<x<2, 0<y<1, 0<z<3), Li_{1+x+y}(Al, Ga)ₓ(Ti, Ge)₂₋ₓSi_{y}P_{3-y}O₁₂ (0≤x≤1, 0≤y≤1), LiₓLa_{y}TiO₃ (0<x<2, 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (M=Te, Nb, or Zr, O≤x≤10), or a combination thereof. Oxide-containing solid electrolytes are produced, for example, by sintering methods.

Oxide-containing solid electrolytes include garnet-type solid electrolytes, such as Li₇La₃Zr₂O₁₂ (LLZO) and Li₃₊ₓLa₃Zr₂₋ₐMₐO₁₂ (M doped LLZO, where M=Ga, W, Nb, Ta, or Al, 0<a<2, 0≤x≤10).

The polymer solid electrolyte may include a combination of a lithium salt and a polymer, or may include a polymer having ion-conducting functional groups. The polymer solid electrolyte may be a polymer electrolyte that is in a solid state at 25° C. and 1 atm. The polymer solid electrolytes may not contain any liquids. The polymer solid electrolyte includes a polymer, and examples of the polymer may include polyethylene oxide (PEO), polyvinylidene fluoride (PVDF), vinylidene fluoride-hexafluoropropylene (PVDF-HFP), polyethylene oxide (PEO), poly(styrene-b-ethylene oxide) block copolymer (PS-PEO), poly(styrene-butadiene), poly(styrene-isoprene-styrene), poly(styrene-b-divinylbenzene) block copolymer, poly(styrene-ethylene oxide-styrene) block copolymer, polystyrene sulfonate (PSS), polyvinyl fluoride (PVF), poly(methylmethacrylate) (PMMA), polyethylene glycol (PEG), polyacrylonitrile (PAN), polytetrafluoroethylene (PTFE), polyethylene dioxythiophene (PEDOT), polypyrrole (PPY), polyacrylonitrile (PAN), polyaniline, polyacetylene, Nafion, Aquivion, Flemion, Gore, Aciplex, Morgane ADP, sulfonated poly(ether ether ketone) (SPEEK), sulfonated poly(arylene ether ketone ketone sulfone) (SPAEKKS), sulfonated poly(aryl ether ketone) (SPAEK), poly[bis(benzimidazobenzisoquinolinones)] (SPBIBI), poly(styrene sulfonate) (PSS), lithium 9,10-diphenylanthracene-2-sulfonate (DPASLi⁺) or a combination thereof, but is not limited thereto, and any material commonly used in polymer electrolytes in the art may be used. Any lithium salt that can be used as a lithium salt in the art may be used. Examples of lithium salts may include LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂) (C_{y}F_{2y+1}SO₂) (x and y are each 1 to 20), LiCl, LiI or a combination thereof. The polymer included in the polymer solid electrolyte may be a compound containing 10 or more, 20 or more, 50 or more, or 100 or more repeating units. The weight average molecular weight of the polymer included in the polymer solid electrolyte may be 1000 Dalton or more, 10,000 Dalton or more, 100,000 Dalton or more, or 1,000,000 Dalton or more.

Gel electrolytes may include polymer gel electrolytes. Gel electrolytes may have a gel state without containing a polymer.

Polymer gel electrolytes may include a combination of liquid electrolytes and polymers, or polymers having ion-conducting functional groups combined with organic solvents. The polymer gel electrolyte may be a polymer electrolyte that is in a gel state at 25° C. and 1 atm. Polymer gel electrolytes may have a gel state without containing liquid. The liquid electrolytes used in polymer gel electrolytes may include an ionic liquid; a combination of a lithium salt and an ionic liquid, a combination of an ionic liquid and an organic solvent, or a combination of a lithium salt, an ionic liquid, and an organic solvent. The polymer used in the polymer gel electrolyte may be one or more of those used in the solid polymer electrolyte. The organic solvent may be an organic solvent used in liquid electrolytes. Examples of organic solvents may include propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, dibutyl carbonate, benzonitrile, acetonitrile, tetrahydrofuran, 2-methyltetrahydrofuran, γ-butyrolactone, dioxolane, 4-methyldioxolane, N,N-dimethylformamide, dimethylacetamide, dimethyl sulfoxide, dioxane, 1,2-dimethoxyethane, sulfolane, dichloroethane, chlorobenzene, nitrobenzene, diethylene glycol, dimethyl ether or a combination thereof. The lithium salt may be a lithium salt used in polymer solid electrolytes. Ionic liquids refer to salts that have a melting point below room temperature, are composed only of ions, and are liquid at room temperature or molten at room temperature. Examples of ionic liquids may include at least one compound including, a) at least one cation of ammonium, pyrrolidinium, pyridinium, pyrimidinium, imidazolium, piperidinium, pyrazolium, oxazolium, pyridazinium, phosphonium, sulfonium, triazolium, or a combination thereof, and b) at least one anion such as BF₄⁻, PF₆⁻, AsF₆⁻, SbF₆⁻, AICI₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃⁻, (FSO₂)₂N⁻, (C₂F₅SO₂)₂N⁻, (C₂F₅SO₂)(CF₃SO₂)N⁻, or (CF₃SO₂)₂N⁻. A polymer solid electrolyte may form a polymer gel electrolyte by being impregnated into a liquid electrolyte in a secondary battery. The polymer gel electrolyte may further contain inorganic particles. The polymer included in the polymer gel electrolyte may be a compound containing 10 or more, 20 or more, 50 or more, or 100 or more repeating units. The weight average molecular weight of the polymer included in the polymer gel electrolyte may be 500 Dalton or more, 1000 Dalton or more, 10,000 Dalton or more, 100,000 Dalton or more, or 1,000,000 Dalton or more.

### Solid Electrolyte Layer: Binder

The solid electrolyte layer 30, 30a, 30b may include a binder. The binder included in the solid electrolyte layer 30, 30a, 30b may be styrene butadiene rubber (SBR), polytetrafluoroethylene, polyvinylidene fluoride, polyethylene, or other materials commonly used as binders in the art, but is not limited to these. The binder of the solid electrolyte layer 30, 30a, 30b may be the same as or different from the binder included in the cathode active material layer 12, 12a, 12b and the anode active material layer 22, 22a, 22b. The binder may be optional. The binder content included in the solid electrolyte layer 30, 30a, 30b may be about 0.1 wt % to about 10 wt % with respect to the total weight of the solid electrolyte layer 30, 30a, 30b.

### Exterior Material

Referring to FIGS. 5 to 7, a unit cell 60, 60a, 60b may include an exterior material 50, 50a, 50b on an electrode assembly 40, 40a, 40b.

The exterior material may surround the unit cell. The exterior material may seal the unit cell. By sealing the unit cell with the exterior material, the infiltration of gas, moisture, and other substances into the unit cell may be prevented. The durability of unit cells may be improved.

The exterior material may have, for example, a single-layer structure or a multi-layer structure. By having a multilayer structure, the exterior material can more effectively seal the unit cell from external environments. The multi-layer structure may have a 2-layer structure to a 100-layer structure, a 2-layer structure to a 20-layer structure, or a 2-layer structure to a 5-layer structure. Each layer constituting the multilayer structure may be independently a polymer layer or a metal layer. The multilayer structure may have a polymer layer/metal layer structure, a first polymer layer/metal layer/second polymer layer structure. The polymer layer may include polyethylene, polypropylene, or nylon. The metal layer may be an aluminum layer.

The exterior material may include an insulating layer. By including an insulating layer, the exterior material can more effectively prevent short circuits tin the all-solid secondary battery.

The exterior material may be a flexible exterior material. By being flexible, the exterior material may easily accommodate unit cells of various shapes. In addition, by effectively transmitting the pressure transmitted by the compression assistance layer 70, 70a, 70b, 70c, 70d to the electrode assembly 40, 40a, 40b, the exterior material may reduce the internal resistance of the electrode assembly 40, 40a, 40b and more effectively reduce the porosity within the cathode layer.

Manufacturing of all-Solid Secondary Battery

In an embodiment, a method of preparing an all-solid secondary battery 1, 1a, 1b may include providing a unit cell 60, 60a, 60b which includes an electrode assembly 40, 40a, 40b including a cathode layer 10, 10a, 10b, an anode layer 20, 20a, 20b, and a solid electrolyte layer 30, 30a, 30b between the cathode layer 10, 10a, 10b and the anode layer 20, 20a, 20b; and an exterior material 50, 50a, 50b on the electrode assembly 40, 40a, 40b; arranging a compression assistance layer 70, 70a, 70b, 70c, 70d on at least one side of the unit cell 60, 60a, 60b to prepare a laminate; and compressing the laminate to prepare an all-solid secondary battery 1, 1a, 1b having a cathode layer 10, 10a, 10b with reduced porosity, wherein the buckling deformation point of the compression assistance layer 70, 70a, 70b, 70c, 70d is 100 MPa or more.

First, a unit cells 60, 60a, 60b is provided. The unit cell 60, 60a, 60b may include an electrode assembly 40, 40a, 40b and an exterior material 50, 50a, 50b. The exterior material 50, 50a, 50b may seal the electrode assembly 40, 40a, 40b. During the process of sealing the electrode assembly 40, 40a, 40b with the exterior material 50, 50a, 50b, the interior of the exterior material 50, 50a, 50b may have a pressure lower than atmospheric pressure due to vacuum. The interior of the exterior material 50, 50a, 50b may be filled with an inert gas such as nitrogen or argon. The oxygen content inside the exterior material 50, 50a, 50b may be less than 0.1%. The electrode assembly 40, 40a, 40b, including a cathode layer 10, 10a, 10b, an anode layer 20, 20a, 20b, and a solid electrolyte layer 30, 30a, 30b between the cathode layer 10, 10a, 10b and the anode layer 20, 20a, 20b, refers to the previously described all-solid secondary battery 1, 1a, 1b.

Next, a laminate is prepared. The laminate may include a compression assistance layer 70, 70a, 70b, 70c, 70d disposed on at least one side of the unit cell 60, 60a, 60b. The compression assistance layer 70, 70a, 70b, 70c, 70d may be disposed on the upper or lower surface of the unit cell 60, 60a, 60b. Alternatively, the compression assistance layers 70, 70a, 70b, 70c, 70d may be disposed on the upper and lower surfaces of the unit cells 60, 60a, 60b, respectively. An all-solid secondary battery including compression assistance layers 70, 70a, 70b, 70c, 70d disposed on both the upper and lower surfaces of a unit cell 60, 60a, 60b may exhibit improved cycle performance compared to an all-solid secondary battery 1, 1a, 1b that includes a compression assistance layer 70, 70a, 70b, 70c, 70d selectively disposed on either the upper or lower surface of the unit cell 60, 60a, 60b.

Next, a laminate is compressed. Since the laminate includes a compression assistance layer 70, 70a, 70b, 70c, 70d, a more uniform pressure may be transmitted to the cathode layer 10, 10a, 10b and/or cathode layer 20, 20a, 20b of the laminate during compression. As a result, the porosity within the cathode layer 10, 10a, 10b and/or the anode layer 20, 20a, 20b may be reduced, and the internal resistance of the cathode layer 10, 10a, 10b and/or the anode layer 20, 20a, 20b may be reduced. When the laminate does not include a compression assistance layer 70, 70a, 70b, 70c, 70d, the pressure may be mainly transmitted to the cathode active material particles having high strength and large volume in the cathode layer 10, 10a, 10b, and the solid electrolyte between the cathode active material particles may not receive adequate pressure. Thereby, the reduction in porosity within the pressurized cathode layer 10, 10a, 10b may be limited, and the reduction in internal resistance of the cathode layer 10, 10a, 10b may also be limited.

The buckling deformation point of the compression assistance layer 70, 70a, 70b, 70c, 70d is 100 MPa or more. By having a high buckling deformation point of 100 MPa or more, the compression assistance layer 70, 70a, 70b, 70c, 70d may transmit uniform pressure to the cathode layer 10, 10a, 10b. By transmitting uniform pressure to the cathode layer 10, 10a, 10b, the internal resistance of the cathode layer 10, 10a, 10b may be further reduced and the porosity of the cathode layer 10, 10a, 10b may be further reduced. The cycle performance of all-solid secondary batteries may be improved. If the buckling deformation point of the compression assistance layer 70, 70a, 70b, 70c, 70d is too low, it may be difficult for the compression assistance layer 70, 70a, 70b, 70c, 70d to transmit uniform pressure to the cathode layer 10, 10a, 10b.

Compression may be performed by a cold isostatic press (CIP), a warm isostatic press (WIP), a hot isostatic press (HIP), a roll press, a plate press, or a combination thereof.

The pressure during the compression may be 100 MPa or more, 200 MPa or more, 300 MPa or more, 400 MPa or more, or 500 MPa or more. By compressing at a high pressure in this range, the internal resistance of the cathode layer 10, 10a, 10b may be further reduced and the porosity of the cathode layer 10, 10a, 10b may be further reduced. The cycle performance of an all-solid secondary battery 1, 1a, 1b may be improved.

The manufactured all-solid secondary battery 1, 1a, 1b may undergo charge-discharge cycles while placed between a pair of end plates and subjected to constant pressure. The pressure applied to the all-solid secondary battery 1, 1a, 1b by the end plates may be a low pressure, such as 10 MPa or less, 5 MPa or less, or 1 MPa or less. One or more all-solid secondary batteries 1, 1a, 1b may be disposed between a pair of end plates and compressed. A buffer layer may be added between the end plate and the all-solid secondary battery 1, 1a, 1b, or between multiple all-solid secondary batteries 1, 1a, 1b. The buffer layer is used, to accommodate the volume changes of an all-solid secondary battery 1, 1a, 1b during charge-discharge. The buffer layer may be a porous elastic sheet. Since the buffer layer may be used to accommodate the volume change of the all-solid secondary battery 1, 1a, 1b during charge-discharge process of the all-solid secondary battery 1, 1a, 1b, it may be distinguished from the compression assistance layer 70, 70a, 70b, 70c, 70d, which is used under high-pressure conditions of 100 MPa or more during the manufacturing process to ensure uniform compression of the cathode layer 10, 10a, 10b. For example, the buffer layer may have substantially identical surface contour on one side and another side, and may not include protrusions or recesses.

The disclosure is explained in more detail through the following examples and comparative examples. However, these examples are merely illustrative and are not intended to limit the scope of the disclosure.

Manufacturing of all-Solid Secondary Battery, Full Cell

### Example 1

### Manufacturing of Cathode Layer

LiNi_{0.8}Co_{0.15}Mn_{0.05}O₂ (NCM) coated with Li₂O—ZrO₂ (LZO) was prepared as a cathode active material. The LZO-coated cathode active material was prepared according to the method disclosed in Korean Publication No. 10-2016-0064942. Li₆PS₅Cl, a crystalline Argyrodite-type solid electrolyte (average particle size (D50)=0.5 μm, crystalline), was used as a solid electrolyte. A polytetrafluoroethylene (PTFE) binder was prepared as a binder. Carbon nanotubes (CNTs) were prepared as a conductive material. These materials were mixed in a weight ratio of cathode active material:solidelectrolyte:conductivematerial:binder of 85:10:3:2 with a xylene solvent to form a slurry, which was then shaped into a sheet. The sheet was vacuum-dried at 40° C. for 8 hours to produce a cathode sheet. The prepared cathode sheet was disposed on a carbon layer of a cathode current collector made of aluminum foil coated with a carbon layer on one side, and processed using a heated roll press at 85° C. to manufacture a cathode layer. The total thickness of the cathode layer was approximately 160 μm. The thickness of the cathode active material layer was approximately 150 μm, and the thickness of the carbon-coated aluminum foil was approximately 10 μm. The cathode layer was cut into pieces measuring 1.7 cm×1.7 cm.

### Manufacturing of Solid Electrolyte Layer

A crystalline Li₆PS₅Cl solid electrolyte with an average particle size (D50) of 3 μm was prepared, and 1 part by weight of a styrene-butadiene rubber (SBR) binder was added to 100 parts by weight of the solid electrolyte to create a mixture. Octyl acetate was added to the mixture while stirring to prepare a slurry. The slurry was applied onto nonwoven fabric using a blade coater and dried in air at 40° C. to obtain a laminate. The obtained laminate was vacuum-dried at 40° C. for 12 hours. Through this process, a solid electrolyte layer with a thickness of 10 μm was manufactured. The solid electrolyte layer was then cut into pieces measuring 2.1 cm×2.1 cm.

### Manufacturing of Anode Layer

A nickel (Ni) foil with a thickness of 10 μm was prepared as an anode current collector. A mixture of carbon black (CB) with a primary particle size of approximately 30 nm and silver (Ag) particles with an average particle size of about 60 nm in a 3:1 weight ratio was prepared as an anode active material.

4 g of the prepared mixture was placed in a container, and 4 g of an NMP solution containing 7 wt % PVDF binder (#9300 from Kureha Corporation) was added to prepare a mixed solution. Subsequently, NMP was gradually added to the mixed solution while stirring to prepare a slurry. The prepared slurry was applied onto the carbon layer of the prepared anode collector using a bar coater and dried in air at 80° C. for 10 minutes. The resulting laminate was vacuum-dried at 40° C. for 10 hours. The dried laminate was flattened using a cold roll press to smoothen the surface of a first anode active material layer. Through this process, an anode layer was fabricated. The thickness of the first anode active material layer in the anode layer was approximately 5 μm. The anode layer was cut into pieces measuring 2.0 cm×2.0 cm.

Manufacturing of all-Solid Secondary Batteries

The anode layer, solid electrolyte layer, and cathode layer were sequentially stacked to prepare an electrode assembly. The electrode assembly was housed in a pouch and subjected to vacuum laminate packing to prepare a sealed unit cell. In the electrode assembly, the anode active material layer of the anode and the cathode active material layer of the cathode were disposed to contact the solid electrolyte layer. The pouch had a multi-layer structure composed of polypropylene/aluminum/nylon.

A compression assistance layer was disposed on a first side adjacent to the cathode layer of the sealed unit cell to prepare a laminate. A 250 μm thick polyimide film (Kapton tape) was used as the compression assistance layer. The polyimide film was a non-porous layer intentionally designed without included pores.

The prepared laminate was submerged in a pressurized medium and processed using a warm isostatic press (WIP) at 85° C. and 500 MPa to fabricate the all-solid secondary battery.

This warm isostatic press treatment reduced the porosity of the cathode active material layer and/or solid electrolyte layer and compacted the solid electrolyte within these layers, improving the battery's performance characteristics.

### Example 2

An all-solid secondary battery was prepared in the same manner as in Example 1, except that the thickness of the polyimide film used as the compression assistance layer was changed to 100 μm.

### Example 3

An all-solid secondary battery was prepared in the same manner as in Example 1, except that the thickness of the polyimide film used as the compression assistance layer was changed to 50 μm.

### Example 4

An all-solid secondary battery was prepared in the same manner as in Example 1, except that the polyimide film used as the compression assistance layer was replaced with a 900 μm thick aluminum/polyethylene terephthalate (Al/PET) laminate film.

The thickness ratio of the aluminum layer to the polyethylene terephthalate layer in the Al/PET laminate film was 1:15.

### Example 5

An all-solid secondary battery was prepared in the same manner as in Example 1, except that the polyimide film used as the compression assistance layer was replaced with a 600 μm-thick aluminum/polyethylene terephthalate (Al/PET) laminate film.

### Example 6

An all-solid secondary battery was prepared in the same manner as in Example 1, except that the polyimide film used as the compression assistance layer was replaced with a 300 μm-thick aluminum/polyethylene terephthalate (Al/PET) laminate film.

### Example 7

An all-solid secondary battery was prepared in the same manner as in Example 1, except that the polyimide film used as the compression assistance layer was replaced with a 500 μm-thick polytetrafluoroethylene (PTFE) film.

### Example 8

An all-solid secondary battery was prepared in the same manner as in Example 1, except that the polyimide film used as the compression assistance layer was replaced with a 1000 μm-thick polytetrafluoroethylene (PTFE) film.

### Example 9

An all-solid secondary battery was prepared in the same manner as in Example 1, except that the polyimide film used as the compression assistance layer was replaced with a 550 μm-thick polystyrene (PS) film.

### Comparative Example 1

An all-solid secondary battery was prepared in the same manner as in Example 1, except that the polyimide film used as the compression assistance layer was replaced with a 500 μm-thick polyurethane rubber (PUR) film.

### Comparative Example 2

An all-solid secondary battery was prepared in the same manner as in Example 1, except that the use of a compression assistance layer was omitted.

### Evaluation Example 1: Measurement of Buckling Deformation Point

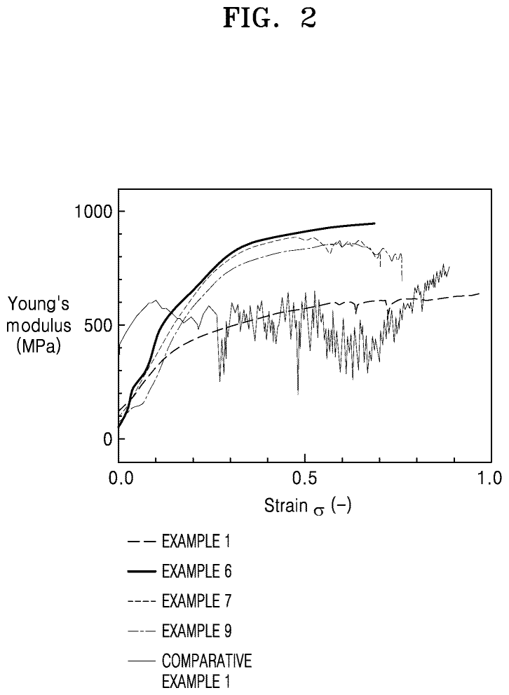

Using a Universal Test Machine (Intron 5565), the strain under compressive stress was measured for 250 μm-thick polyimide (PI) film used in Example 1, the 300 μm-thick aluminum/polyethylene terephthalate (Al/PET) film used in Example 6, the 500 μm-thick polytetrafluoroethylene (PTFE) film used in Example 7, the 550 μm-thick polystyrene (PS) film used in Example 9, and the 500 μm-thick polyurethane (PUR) film used in Comparative Example 1. From these measurements, the Young's modulus under stress and the buckling deformation point were determined. Results are summarized in Table 1, FIG. 1, and FIG. 2. FIG. 1 shows the stress-strain diagram. FIG. 2 illustrates the Young's modulus-strain diagram. In FIG. 2, the point where the Young's modulus increases and then starts to decrease corresponds to the buckling deformation point. The buckling deformation point is the strain level at which vertical deformation occurs in the specimen due to compressive force, and the deformation remains even after the compressive force is removed. The buckling deformation point corresponds, for example, to the yielding point of a compressed material.

In FIG. 1, a stress-strain hysteresis loop was obtained from the compression-relaxation cycle including the compression and relaxation processes. In the stress-strain hysteresis loop of FIG. 1, the difference between the first stress during the compression process and the second stress during the relaxation process was measured at the strain level of 50% (i.e., where the y-axis=0.5), and the difference between the first stress and the second stress, as well as the ratio of the second stress to the first stress (second stress/first stress), is summarized in Table 1.

TABLE 1

| | | | Difference between | Second |
|---|---|---|---|---|
| | Buckling | | the first stress and | stress/first |
| | deformation | Young's | the second stress at | stress at 50% |
| | point | modulus* | 50% strain | strain |
| | [MPa] | [MPa] | [MPa] | [MPa/MPa] |
| Example 1 (PI film) | >500 | 601 | 5 | 0.98 |
| Example 6 (AI/PET film) | >500 | 885 | 8 | 0.98 |
| Example 7 (PTFE film) | 360 | 852 | 25 | 0.92 |
| Example 9 (PS film) | 422 | 827 | 18 | 0.94 |
| Comparative Example 1 | 75 | 540 | 175 | 0.41 |
| (PUR Film) | | | | |

*The Young's modulus values in Table 1 were measured at a compressive stress of 300 MPa.

As shown in Table 1, the buckling deformation point of the polyurethane (PUR) film used in Comparative Example 1 was below 100 MPa, whereas the films used in Examples 1, 6, 7, and 9 exhibited buckling deformation points of 100 MPa or higher.

As shown in FIGS. 1 and 2, the films in Examples 1 and 6 did not exhibit a buckling deformation point even under compressive stress of 500 MPa.

The Young's modulus of the polyurethane film in Comparative Example 1 was less than 600 MPa, whereas the polymer films used in Examples 1, 6, 7, and 9 exhibited Young's modulus values greater than 600 MPa.

As shown in Table 1 and FIG. 1, the film in Comparative Example 1 exhibited significant hysteresis during the compression and relaxation processes. In contrast, the films used in Examples 1, 6, 7, and 9 showed significantly reduced hysteresis.

### Evaluation Example 2: Evaluation of Surface Roughness of Compression Assistance Layer

From the scanning electron microscope image of the cross-section of the all-solid secondary battery of Example 1, it was confirmed that the surface of the cathode layer included protrusions and recesses, and that one (first) side of the compression assistance layer adjacent to the cathode layer included recesses and protrusions corresponding to the protrusions and recesses of the cathode layer. In contrast, no protrusions or recesses were observed on a second side of the compression assistance layer opposite the first side of the compression assistance layer adjacent to the cathode layer.

From the scanning electron microscope image of the cross-section of the all-solid secondary battery of Example 1, the maximum roughness depth (Rₘₐₓ) of the first side of the compression assistance layer adjacent to the cathode layer and the maximum roughness of the second side of the compression assistance layer were measured, respectively. The maximum roughness depth (Rₘₐₓ) of the first side of the compression assistance layer adjacent to the cathode layer was larger than the maximum roughness depth of the second side of the compression assistance layer. The maximum roughness depth of the first side of the compression assistance layer adjacent to the cathode layer was 5 μm.

From the scanning electron microscope image of the cross-section of the all-solid secondary battery of Example 1, the mean roughness Rₐ of the first side of the compression assistance layer adjacent to the cathode layer and the average roughness of the second side of the compression assistance layer were measured, respectively. The average roughness Rₐ of the first side of the compression assistance layer adjacent to the cathode layer exhibited a larger value than the average roughness of the second side of the compression assistance layer. The average roughness Rₐ of the first side of the compression assistance layer adjacent to the cathode layer was 1 μm.

From the scanning electron microscope image of the cross-section of the all-solid secondary battery of Example 1, the RMS roughness R_{q} of first side of the compression assistance layer adjacent to the cathode layer and the RMS roughness R_{q} of the second side off the compression assistance layer were measured, respectively. The RMS roughness R_{q} of the first side of the compression assistance layer adjacent to the cathode layer showed a larger value than the RMS roughness R_{q} of the second side of the compression assistance layer. The RMS roughness R_{q} of the first side of the compression assistance layer adjacent to the cathode layer was 1 μm.

### Evaluation Example 3: Evaluation of the Porosity of Cathode Active Material Layer

The first porosity was measured by measuring the area of pores in the total area of the cathode active material layer from scanning electron microscope images of the cross-sections of the all-solid secondary batteries of Examples 1 and 4. The first porosity was calculated from the following Equation 1.

The second porosity was measured by measuring the area of pores in the area remaining after excluding the area of the cathode active material from the total area of the cathode active material layer from scanning electron microscope images of the cross-sections of the all-solid secondary batteries of Examples 1 and 4. The second porosity was calculated from the following Equation 2.

$$First Porosity = [ Pore Area / Total Cathode Active Material Layer Area ] \times 100 \qquad Equation 1$$

$$Second Porosity = [ Pore Area / ( Cathode Active Material Layer Area - Cathode Active Material Area ) ] \times 100 \qquad Equation 2$$

The measurement results are shown in Table 2 below.

TABLE 2

| | First | Second |
|---|---|---|
| | Porosity | Porosity |
| | [%] | [%] |
| Example 1 (PI film, 250 μm) | 5.7 ± 0.2 | 7.6 |
| Example 4 (AI/PET film, 500 μm) | 4.3 ± 0.2 | 9.5 |
| Comparative Example 2 (without | 9.2 ± 0.8 | 14.8 |
| compression assistance layer) | | |

As shown in Table 2, the cathode active material layers of the all-solid batteries in the examples exhibited reduced first and second porosities compared to the Comparative Example 2.

Evaluation Example 4: Measurement of Charge-Discharge Characteristics (I) The all-solid secondary batteries manufactured in Examples 1 to 8 and Comparative Examples 1 and 2 were compressed to 1 Newton per square millimeter (N/mm²) using a pressing jig, then the compression was released, left for 1 hour, and then recompressed 2 N/mm², and the charge-discharge characteristics were measured under compression. The pressing jig consists of a pair of pressing plates. An all-solid secondary battery was disposed between the pair of pressing plates, and the gap between the pressing plates was reduced to apply pressure to the all-solid secondary battery.

For the all-solid secondary batteries manufactured in Examples 1 to 8, Comparative Example 1, and Comparative Example 2, a constant current charge was applied at 45° C. with a current rate of 0.1 Coulomb (C) until the voltage reached 4.5 V (vs. Li). Subsequently, in constant voltage mode, the voltage was maintained at 4.5 V until the current dropped to a cut-off level of 0.02 C. Subsequently, the discharge was performed at a constant current of 0.1 C rate until the voltage reached 2.5 V (vs. Li) during discharge. (First Cycle)

The lithium battery that had undergone the first cycle was charged under constant current at 25° C. with a current of 0.1 C rate until the voltage reached 4.5 V (vs. Li), and then cut-off was performed at a current of 0.02 C rate while maintaining 4.5 V in constant voltage mode. Subsequently, the discharge was performed at a constant current of 0.33 C rate until the voltage reached 2.5 V (vs. Li) during discharge. (Second Cycle)

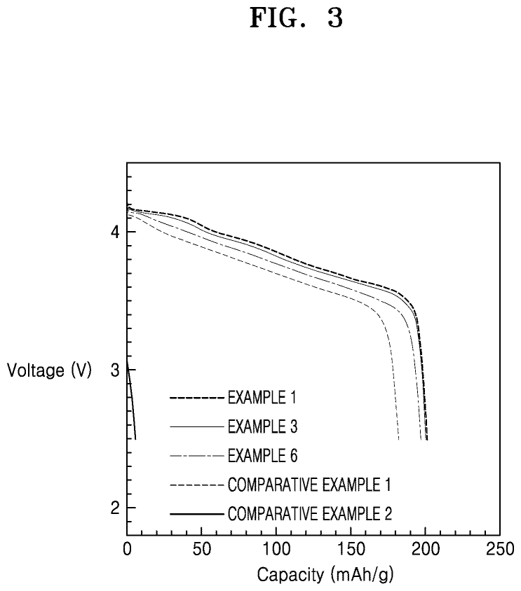

The discharge capacity and charge-discharge efficiency were measured in the second cycle, and the results are shown in Table 3. The discharge profiles of Example 1, Example 3, Example 6, Comparative Example 1, and Comparative Example 2 are shown in FIG. 3.

The charge-discharge efficiency was calculated from the following Equation 3.

$$Charge - Discharge efficiency ( \% ) = [ Second cycle discharge capacity / Second capacity charge capapcity ] \times 100 \qquad Equation 3$$

TABLE 3

| | | Charge- |
|---|---|---|
| | Discharge | Discharge |
| | capacity | efficiency |
| | [mAh/g] | [%] |
| Example 1 (PI film, 250 μm) | 201 | 81.7 |
| Example 2 (PI film, 100 μm) | 199 | 81.9 |
| Example 3 (PI film, 50 μm) | 201 | 82.0 |
| Example 4 (AI/PET film, 900 μm) | 200 | 82.1 |
| Example 5 (AI/PET film, 600 μm) | 196 | 82.4 |
| Example 6 (AI/PET film, 300 μm) | 185 | 81.8 |
| Example 7 (PTFE film, 500 μm) | 197 | 81.0 |
| Example 8 (PTFE film, 1000 μm) | 180 | 79.2 |
| Comparative Example 1 (PUR film, 500 μm) | 174 | 81.3 |
| Comparative Example 2 (without | 10 | 2.3 |
| compression assistant layer) | | |

As shown in Table 3 and FIG. 3, the all-solid secondary batteries of Examples 1 to 8 had improved discharge capacities compared to the all-solid secondary batteries of Comparative Examples 1 and 2.

The charge-discharge efficiency was higher for Examples 1 through 8 than for Comparative Example 1.

### Evaluation Example 5: Measurement of Charge-Discharge Characteristics (II)

A charge-discharge test was conducted under the same conditions as in Evaluation Example 1, except that a 500 μm-thick polyurethane (PUR) film used in Comparative Example 1 was added as a cushioning layer between the pressing plate of the pressing jig and the upper surface of the all-solid secondary battery and between the pressing plate and the lower surface of the all-solid secondary battery. The charge-discharge test results showed trends similar to Evaluation Example 4, where no cushioning layer was used. The all-solid secondary batteries of Examples 1 to 8 had improved discharge capacity and initial efficiency compared to the all-solid secondary batteries of Comparative Examples 1 to 2.

### Evaluation Example 6: Life Characteristics Analysis (III)

The all-solid secondary batteries manufactured in Examples 1 to 9 and Comparative Examples 1 to 2 were compressed at a pressure of 1 N/mm² using a pressing jig, then the pressure was released, left for 1 hour, and then compressed again to 2 N/mm², and the charge-discharge characteristics were measured under compressed state. The pressing jig consists of a pair of pressing plates. An all-solid secondary battery was disposed between a pair of pressing plates, and the batteries were compressed by reducing the gap between these plates.

For the all-solid secondary batteries manufactured in Examples 1, 4, and Comparative Example 1, constant current charging was performed at 45° C. at a constant current of 0.1 C until the voltage reached 4.5 V (vs. Li), and then cut-off was performed at a current of 0.02 C rate while maintaining 4.5 V in constant voltage mode. Subsequently, the discharge was performed at a constant current of 0.1 C rate until the voltage reached 2.5 V (vs. Li) during discharge. (First cycle)

The lithium battery that had undergone the first cycle was charged under constant current at 25° C. with a current of 0.1 C rate until the voltage reached 4.5 V (vs. Li), and then cut-off was performed at a current of 0.02 C rate while maintaining 4.5 V in constant voltage mode. Subsequently, the batteries discharged at a constant current of 0.33 C rate until the voltage reached 2.8 V (vs. Li). This charge-discharge cycle was repeated up to 100 cycles. (Second to 100th cycle)

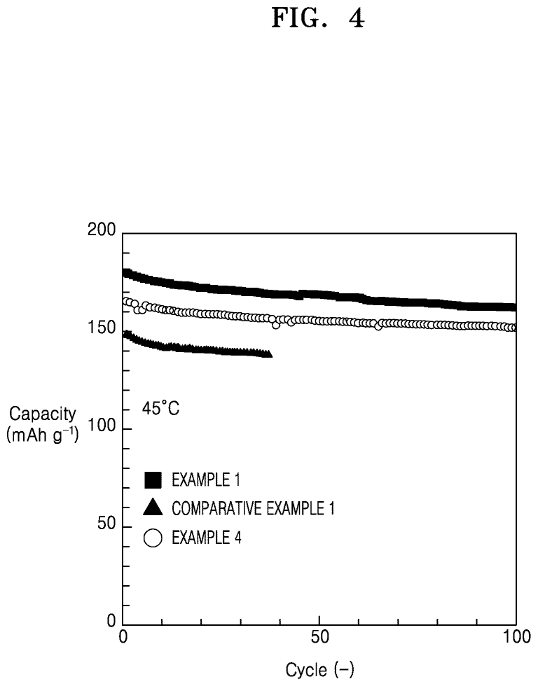

Some of the results of the charge-discharge experiment are shown in FIG. 4. As shown in FIG. 4, the all-solid secondary batteries of Examples 1 and 4 were capable of stable charge-discharge up to 100 cycles.

In contrast, the all-solid secondary battery of Comparative Example 1 did not exhibit discharge capacity and charge-discharge was stopped due to a short circuit near the 40th cycle.

The all-solid secondary batteries of Examples 1 and 4 had improved life characteristics compared to the all-solid secondary battery of Comparative Example 1.

According to an aspect, according to the novel all-solid secondary battery, it is possible to provide an all-solid secondary battery having reduced porosity and improved charge-discharge characteristics by uniformly compressing the cathode layer.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An all-solid secondary battery comprising a unit cell and a compression assistance layer on at least one side of the unit cell,
the unit cell comprising an electrode assembly and an exterior material on the electrode assembly,
the electrode assembly comprising a cathode layer, an anode layer, and a solid electrolyte layer between the cathode layer and the anode layer,
wherein a buckling deformation point of the compression assistance layer is 100 megaPascals or more.

2. The all-solid secondary battery of claim 1,
wherein the buckling deformation point of the compression assistance layer is 300 megaPascals or more.

3. The all-solid secondary battery of claim 1,
wherein a Young's modulus of the compression assistance layer is 600 megaPascals or more.

4. The all-solid secondary battery of claim 1,
wherein in a stress-strain curve of a compression-relaxation cycle including a compression process and a relaxation process, which are for the compression assistance layer,
a difference between a first stress corresponding to 50% strain of the compression assistance layer during the compression process and
a second stress corresponding to 50% strain of the compression assistance layer during the relaxation process is 50 megaPascals or less.

5. The all-solid secondary battery of claim 1, wherein a thickness of the compression assistance layer is about 1 micrometer to about 1 millimeter,
wherein the compression assistance layer has a single-layer structure or a multi-layer structure, and
wherein one or more layers constituting the single-layer structure or the multi-layer structure are insulating layers.

6. The all-solid secondary battery of claim 1,
wherein the compression assistance layer is disposed adjacent to the cathode layer.

7. The all-solid secondary battery of claim 1,
wherein the compression assistance layer comprises a polymer, a metal, a wood, or a combination thereof,
wherein the polymer comprises polyimide, polyethylene terephthalate, polytetrafluoroethylene, polystyrene, polycarbonate, polyvinyl chloride, polyvinyl alcohol, polyacrylate, polyethylene, polypropylene, polystyrene, polyisobutylene, polyvinyl chloride, vinyl acetate resin, polytetrafluoroethylene, polyacrylonitrile, polymethyl methacrylate, polyethylene terephthalate optionally blended with cotton or rayon, nylon, a phenol-formaldehyde polymer, urea resin, polysiloxane, or a combination thereof, and
wherein the metal comprises a metal belonging to Groups 2 to 16 of the periodic table of elements.

8. The all-solid secondary battery of claim 1,
wherein the cathode layer comprises a cathode current collector and a cathode active material layer,
wherein the compression assistance layer comprises: a first side adjacent to the cathode active material layer; and
a second side opposing the first side,
wherein a surface of the cathode active material layer adjacent to the first side of the compression assistance layer comprises a first protrusion and a first recess, and
wherein the first side of the compression assistance layer comprises a second recess corresponding to the first protrusion; and a second protrusion corresponding to the first recess.

9. The all-solid secondary battery of claim 8,
wherein a maximum roughness depth of the first side of the compression assistance layer is greater than a maximum roughness depth of the second side of the compression assistance layer, and
wherein the maximum roughness depth of the first side of the compression assistance layer is 1.1 micrometers or more.

10. The all-solid secondary battery of claim 8,
wherein an average roughness of the first side of the compression assistance layer is greater than an average roughness of the second side of the compression assistance layer, and
wherein the average roughness of the first side of the compression assistance layer is 1.0 micrometer or more.

11. The all-solid secondary battery of claim 8,
wherein a root mean square roughness of the first side of the compression assistance layer is greater than a root mean square roughness of the second side of the compression assistance layer, and
wherein the root mean square roughness of the first side of the compression assistance layer is 1.0 micrometer or more.

12. The all-solid secondary battery of claim 1,
wherein the compression assistance layer is a non-porous layer, and
wherein the compression assistance layer is separable from the unit cell.

13. The all-solid secondary battery of claim 1,
wherein the cathode layer includes a cathode current collector and a cathode active material layer,
wherein a first porosity of the cathode active material layer is less than 8%, and
wherein the first porosity is a ratio of an area occupied by pores to an entire area of a cross-section of the cathode layer in a scanning electron microscope image of a cross-section of the cathode active material layer.

14. The all-solid secondary battery of claim 1,
wherein the cathode layer comprises a cathode current collector and a cathode active material layer,
wherein a second porosity of the cathode active material layer is 14% or less, and
wherein the second porosity is a ratio of an area occupied by pores to an entire area excluding an area of a cathode active material in a scanning electron microscope image of a cross-section of the cathode active material layer.

15. The all-solid secondary battery of claim 1,
wherein the cathode layer comprises a cathode current collector and a cathode active material layer, and the anode layer comprises an anode current collector and a first anode active material layer, and
wherein a ratio (B:A) of an initial charge capacity (B) of the first anode active material layer and an initial charge capacity (A) of the cathode active material layer is 0.001:1 to 0.45:1.

16. The all-solid secondary battery of claim 1,
wherein the solid electrolyte layer comprises a sulfide-containing solid electrolyte, an oxide-containing solid electrolyte, a polymer solid electrolyte, or a combination thereof.

17. The all-solid secondary battery of claim 1,
wherein the exterior material seals the unit cell,
wherein the exterior material has a single-layer structure or a multi-layer structure,
wherein the exterior material comprises an insulating layer, and
wherein the exterior material is a flexible exterior material.

18. A method of preparing an all-solid secondary battery, the method comprising:
providing a unit cell which comprises an electrode assembly and an exterior material on the electrode assembly, the electrode assembly comprising a cathode layer having a first porosity, an anode layer, and a solid electrolyte layer between the cathode layer and the anode layer;
arranging a compression assistance layer on at least one side of the unit cell; and
simultaneously compressing the unit cell and the compression assistance layer to prepare the all-solid secondary battery wherein the cathode layer has a second porosity that is less than the first porosity,
wherein a buckling deformation point of the compression assistance layer is 100 megaPascals or more.

19. The method of claim 18,
wherein the compressing is performed by a cold isostatic press, a warm isostatic press, a hot isostatic press, a roll press, a plate press, or a combination thereof.

20. The method of claim 18,
wherein a pressure during the compressing is 100 megaPascals or more.
